(19) United States
(12) Patent Application Publication
(10) Pub. No.: US 2025/0380028 A1
(43) Pub. Date: Dec. 11, 2025

(54) OPTIMIZED SYSTEM AND BUSINESS METHODS FOR IMPROVED TELEVISION RECEPTION

(71) Applicant: Robert Kulakowski, Rancho Santa Fe, CA (US)

(72) Inventor: Robert Kulakowski, Rancho Santa Fe, CA (US)

(21) Appl. No.: 19/207,327

(22) Filed: May 13, 2025

Related U.S. Application Data
(60) Provisional application No. 63/647,072, filed on May 13, 2024.

(51) Int. Cl. H04N 21/45; H04H 60/49; H04H 60/98; H04N 21/41; H04N 21/4147; H04N 21/81

(52) U.S. Cl. CPC H04N 21/4524; H04H 60/49; H04H 60/98; H04N 21/41265; H04N 21/4147; H04N 21/812

(57) ABSTRACT

A system and method for providing reliable, legally compliant access to geographically restricted ATSC television signals via user-owned devices hosted in a datacenter. The invention verifies the physical address of each applicant to ensure eligibility within the designated market area before installation. It eliminates the need for rooftop or indoor antennas, resolving common ATSC reception challenges, including interference, terrain obstruction, and lightning risks. Designed for ease of use by non-technical users, the system provides consistent high-quality reception through a managed datacenter infrastructure. The invention complies with legal boundaries set by the U.S. Supreme Court's ruling in ABC v. Aereo by ensuring individualized device ownership and avoiding centralized retransmission. An optional encrypted group addressing mode further reduces energy and hardware redundancy while enforcing regional access through a conditional access system with access limited to persons with validated addresses and members of the datacenter.

### PRIORITY CLAIM

This applicatiohn claims the benefit of U.S. Provisional Application No. 63/647,072, filed on May 13, 2024, with title “Optimized System and Business Method For Improved Television Reception: under 35 U.S.C. § 119(e). The entire contents of the provisional application are incorporated herein by reference.

### FIELD OF THE INVENTION

The present invention relates to a business method and system for managing a datacenter that hosts user-owned devices used to access geographically restricted ATSC television signals. The method ensures that only eligible users residing in the relevant geographic area can install and access their devices remotely.

The present invention relates to a novel system and business methods for improving television (TV) reception while preserving the copyrights for content owners and optionally replacing broadcast ads with higher value ads.

### BACKGROUND

ATSC television signals are geographically restricted in accordance with licensing agreements and regulatory frameworks such as the FCC's Designated Market Areas (DMAs). Traditional access to these signals requires that users be physically located within the geographic region where the signal is broadcast. With the increasing demand for mobile and remote access to live TV, especially local channels, new systems are required to maintain legal compliance while enabling flexible access.

In the United States and other parts of the world there are free television (TV) channels broadcasted over the public airwaves such as the ATSC 1.0 and ATSC 3.0 broadcast standards. ATSC is the Advanced Television Standards Committee, a digital television international standards organization. Broadcaster such as ABC, CBS, NBC, and Fox Television in the USA provide excellent TV programs free of charge to viewing audiences in specific defined geographic areas.

ATSC provides fantastic TV channels for some people but is often unavailable for the majority of people in an ATSC broadcast area. What limits ATSC is a multitude of issues associated with broadcasting TV using Radio Frequency (RF) transmission. Examples of RF issues that plague many people in an ATSC viewing area are the topography of the receiving location, the signal strength being too weak due to the distance to towers, no direct line of sight to the towers, multipath interference, even the direction a house is facing or the side of a street it is on. For example, in my home town I can only receive 2 of the 67 available TV channels broadcasted in my area using an expensive outdoor pole mounted TV antenna. In addition to RF issues many people lack the technical skills require to configure an ATSC receiver, to configure the network and router settings to stream the ATSC content to their phones and tablets over the Internet. Additional safety issues arise when receiving ATSC TV channels requires one or more outdoor antennae that includes adding proper antenna grounding, aligning the antenna, and provide lightning protection for the antenna to keep their house and home equipment safe.

This invention eliminates the above problems by providing a location called a data center where device owners can house their devices in a location that has excellent reception for TV the devices owned by individuals. The center can be considered a co-location facility like the colocation facilities or datacenter facilities provided in the computer industry. The term datacenter is also used to describe the inventive elements of this patent application as installed in Internet Service Providers (ISP), cable company, mobile phone carriers, satellite TV providers and other companies offering TV services.

The inventive system and business model is an ATSC colocation center for providing a location within a strong signal reception area for owners of ATSC devices. Device owners who live in the TV broadcast area serviced by TV broadcasters rent space in the colocation center for the devices they own. The owner devices are installed in the datacenter and managed by the owner. A device owners physical address is verified before a device is installed in the ATSC colocation datacenter.

### BRIEF DESCRIPTION OF THE DRAWINGS

FIG. 1 proves a high-level block diagram of the invention.

FIG. 2 provides a high-level block diagram of the application a device owner uses to remotely access their devices housed in the datacenter.

FIG. 3 provides a high-level block diagram of the invention when only a portion of the ATSC processing is performed in the datacenter with additional processing of the ATSC signal performed by a device remote to the datacenter.

### PRIOR ART

U.S. Pat. No. 8,423,004 B2, titled “System and method for authorizing the reception and transmission of broadcast signals.” Goodmon's system and method deliver geographically restricted content, such as over-air broadcast programming, to a recipient located in the geographic broadcast area using additional Over-The-Air (OTA) signals added to the ATSC broadcast signal. In Goodmon, if an OTA is not detected there is no access allowed and the inventive steps of this invention does not require an OTA signal to verify physical location

### BACKGROUND

The system described in this invention ensures copyright compliance through individualized device ownership, geographic address verification, and encrypted direct-to-owner content access. Each user (device owner) receives content only through a device owned or controlled exclusively by them, avoiding any form of shared infrastructure model processing copyrighted content. The decentralized access paradigm, combined with secure remote control and persistent geographic eligibility enforcement, positions the system outside the definition of unauthorized retransmission. The system includes processing to enforce copyright law compliance even during a trial access period with an initial address verification and later additional address eligibility verification adding additional legal safeguards to ensure copyrights are not violated. The datacenter operator elements of this invention do not access, process or stream any copyrighted materials (the actual audio or visual images), thus not performing any of the copyrighted video processing performed by cable companies, ISPs and satellite TV providers wherein these companies decode the incoming audio and video, process the incoming audio and video and transmit the copyrighted material to the public.

The system of this invention avoids retransmission by requiring all content process and streaming of copyrighted video to be processed in a user owned device or a group members owned device. No datacenter-managed content processing of copyrighted material occurs. Datacenter provides network connection, optionally an antenna, optionally group address management and networking redirection of encrypted content where the datacenter manager cannot decrypt, process or access the copyrighted video materials. An encrypted group addressing element of this invention complies with FCC and copyright exemptions by maintaining individual device boundaries with such device boundaries not accessible to the data center operator. Isolation of the datacenter operator is explicitly supported through the exclusive user-device relationship. Temporary access under trial mode is also framed as individualized and exclusive device use with subsequent verification of long-term geographic eligibility. Temporary access such as a trial mode assigns ownership of a device in a datacenter to an individual for a limited timeframe subject to temporary or permanent ownership transfer for the datacenter device. Temporary access such as trial mode in a datacenter is also supported wherein an owner's device is provided to the datacenter and installed into the datacenter subject to any address verification steps described herein. Temporary access such as a trial mode assigns ownership with exclusive device control to an individual for a limited timeframe. The user is the device owner during this period. Ownership may later be revoked, and compliance enforcement ensures uninterrupted access is only granted upon verification and re-verification of long-term geographic eligibility.

The system assures copyright compliance by never decoding, rendering, or otherwise processing copyrighted video or audio content within any datacenter infrastructure. The system of this invention does not transmits a performance”, it does not “communicates the same contemporaneously perceptible images and sounds to multiple people.” In the present invention, all video decoding and playback occur within user-owned or user-assigned devices, under the exclusive control of the user. In an encrypted group addressing mode of this invention, the datacenter operator never possesses the ability to decrypt or view copyrighted content; all such content remains encrypted and is only decrypted by eligible, address verified users. This architectural separation between reception, encryption, and decoding ensuring that the datacenter never functions as a performer or re-transmitter of copyrighted works.

Summary of the Invention: The invention offers significant practical benefits for consumers. It eliminates the need for physical antennas in homes, avoiding installation challenges and safety concerns such as lightning exposure and rooftop mounting. This is especially beneficial for urban residents, renters, and individuals in multi-unit dwellings where antenna placement is difficult or restricted. The system improves ATSC reception quality by situating devices in optimal broadcast zones within datacenters, mitigating terrain interference, signal multipath distortion, or building obstructions common in residential reception. Importantly, it abstracts away technical complexity, making local TV access possible for non-technical users through simple remote interfaces—without requiring any networking, tuning, or maintenance skills. It also eliminates the need for people to purchase expensive streaming hardware devices such as Set Top Boxes and properly install this hardware in their homes.

The present invention ensures that each user accesses content only through their individually owned and geographically verified device, thereby avoiding retransmitting of copyrighted material. As well as avoiding retransmission of copyrighted materials to the public. This individualized access structure, combined with strong authentication and encryption, aligns with personal-use exemptions and is specifically designed to assure datacenter compliance with all copyright laws associated with the enjoyment of ATSC transmitted programs by hardware owned by individuals.

This patent provides a novel and legally compliant system for delivering remote access to local broadcast television by hosting user-owned devices in datacenters, avoiding the retransmission restrictions that have challenged past services like Aereo and Locast. Each user provides or purchases their own authenticated device, installed only after verifying geographic eligibility within the relevant broadcast market, ensuring individualized access and legal alignment with personal-use exemptions under U.S. copyright and FCC regulations. Additionally, this invention covers a power-efficient group addressing method that allows one device to securely transmit an encrypted stream to multiple eligible users, with decryption controlled by a conditional access system. An eligible user for accessing group addressed content in one example is an owner of a device with validated address in a datacenter. The datacenter operator never accesses unencrypted content, preserving both legal and content security boundaries.

The invention provides a novel approach to managing a datacenter where applicants are only permitted to install their devices if their physical address is within the geographic region permitted by ATSC broadcast restrictions. The datacenter provides power, network access, and optionally a connection to an ATSC antenna feed. The system includes address verification methods at installation and periodically thereafter, with automatic enforcement measures to disable access, or reduce access if eligibility criteria are no longer met. In an alternative embodiment, a single applicant device may tune to a local broadcast channel, encrypt the received content, and deliver the encrypted output to multiple verified datacenter members. A conditional access system ensures that only members with verified addresses in the geographic restriction area receive the corresponding decryption keys, thereby enabling scalable, compliant video distribution without exposing unencrypted content to the datacenter operator.

One element of the invention provides a unique datacenter-hosted architecture where each user installs their own authenticated device—subject to geographic eligibility verification—ensuring compliance with FCC Designated Market Areas. Additionally, the invention introduces a proprietary group addressing method that enables encrypted distribution of a single device's output to multiple verified users, drastically reducing power and hardware costs while preserving content security. A conditional access system controls decryption rights, blocking operator access and ensuring only eligible users within the licensed broadcast region can view the content. This approach distinguishes itself from prior services deemed infringing (e.g., Aereo, Locast) by ensuring individualized, encrypted access to copyrighted material to only device owners with validated addresses. The inventive steps herein provide a legally compliant local TV over IP infrastructure, simplifying streaming, and broadcast infrastructure modernization without the problems associated with ATSC reception and streaming

### DETAILED DESCRIPTION

In this patent the term owner, customer or device owner will be used to refer to the owner of a physical device such as an ATSC Set Top Box, ATSC USB dongle, TV set, mobile device or similar device that can receive TV channels. Owner or customer will refer to an individual who owns a device that is installed in a datacenter for receiving ATSC signals in the datacenter and sending a digital stream in any format to the owner for display on an owners player device such as a smart or connected TV set, mobile phone or tablet application, Set Top Box connected to a TV set, connected TV such as those sold by LG or Samsung, a Personal Computer, a gaming device or console, an application of any kind including a video player of any kind or other similar device capable of displaying video or playing audio.

As used herein, the term “module” may refer to any combination of hardware, firmware, software, or logic configured to perform the specified function. A module may be implemented as a single device or as distributed components across multiple physical or virtual systems, including but not limited to microprocessors, programmable logic devices, application-specific integrated circuits (ASICs), field-programmable gate arrays (FPGAs), or computing environments executing software instructions.

Similarly, “steps” or “operations” in method claims may be executed by a computer system, processing circuit, firmware routine, or software application running on a programmable device. Unless explicitly stated otherwise, no particular order of execution is required for method steps, and steps may be performed in parallel or out of order as permitted by the system architecture.

Any functionality described herein may be implemented using non-transitory computer-readable media storing executable instructions that, when executed by one or more processors, cause the system to perform the described functionality. Such media may include RAM, ROM, flash memory, magnetic storage, optical media, or other suitable memory technologies.

To create a well-rounded and defensible patent specification, you should include several key boilerplate language sections beyond your claims. These provisions help support broad interpretation, claim flexibility, and legal protection across jurisdictions and technology shifts.

### Definition of Terms and Flexible Interpretation Use Herein.

As used herein, the terms “comprising,” “including,” and “having” are intended to be open-ended and mean “including but not limited to.” The term “configured to” is intended to describe structure that is adapted or arranged to perform a specified function, and does not imply any limitation as to implementation technique or timing.

### Optional Elements and Embodiments

Any component, step, or feature described herein may be optional unless explicitly stated otherwise. The embodiments described are illustrative and not limiting. Variations in implementation that achieve substantially the same result are within the scope of this disclosure. Equivalent Structures/Means-Plus-Function Support Where a system or method is described in functional terms, it is intended that the disclosure include all structural equivalents capable of performing the same function, including those developed after the filing date of this application. The Applicant does not intend to invoke 35 U.S.C. § 112(f) unless the claim explicitly uses the term “means for. Order of Operations for Method Claims, unless explicitly stated, the order of steps or operations described in a method should not be construed as required. Steps may be performed in a different order or in parallel unless the context requires otherwise. Multiple Implementations and Examples are provided. The disclosed systems and methods may be implemented in a variety of configurations and architectures, including on-premise, cloud-based, virtualized, or hybrid environments. Specific examples are provided for clarity and should not be construed as limiting the scope of the invention. The provided examples are non-limiting examples. References to specific examples, figures, modules, or features are provided to aid understanding and are not intended to limit the invention. The full scope of the invention is defined by the claims and their legal equivalents. For Jurisdictional Compatibility for International patent applications the invention may be practiced in jurisdictions with differing legal requirements. References to particular laws (e.g., FCC regulations or U.S. ATSC standards) are illustrative and may be substituted by equivalent standards in other regions.

### Advantages of the Invention

Eliminates the need for users to install or maintain antennas in their homes, thereby avoiding complex setup, signal loss, or equipment exposure to lightning and weather-related risks. Solves indoor reception problems in urban environments or multi-dwelling units where antenna placement is limited or ineffective. Provides a seamless experience for non-technical users by abstracting away all local setup and networking configuration issues, offering simple access through a secure network interface for streaming local TV channels. Ensures consistent high-quality ATSC reception regardless of terrain, building obstructions, or geographic anomalies that may hinder at-home signal reliability. Reduces total energy consumption and hardware requirements via optional group addressing while maintaining content isolation and security. The system described in the present patent avoids central retransmission by ensuring each user has exclusive ownership and control of a personal device, which the device owner is verified to be physically located within a legally permissible broadcast market. Furthermore, in the optional group addressing mode, encrypted content streams are not viewable by the datacenter operator, and decryption is managed through a conditional access system that ensures only geographically compliant users receive access keys. These safeguards, combined with continual address validation and private-device architecture, place the invention outside the scope of retransmission liability as defined by the Aereo decision and consistent with retransmission consent obligations under 47 U.S.C. § 325(b)[2] and FCC enforcement rules outlined in 47 C.F.R. § 76.64 and § 76.1200 et seq.[3] and reinforce its compliance with copyright and communications law.

The present invention guarantees that each user owns and remotely accesses their personal device placed within the broadcast DMA, which functions no differently than a home antenna situated at a verified residence. The datacenter operator does not aggregate or rebroadcast content, and no public performance occurs because each stream originates from the user's own device. This critical legal distinction aligns the invention with private-use exemptions and ensures protection from the liabilities that invalidated services like Aereo.

The inclusion of optional group addressing with encrypted multicast preserves personal-use principles by tying decryption to verified eligibility and preventing operator access to unencrypted content.

This invention also enables compliant remote access to local ATSC content where reception may be limited due to physical RF transmission issues.

This invention provides business methods and techniques for improved TV reception for devices that are owned by individuals living in a datacenter's geographic area. The device owners physical address is verified to be in a predetermined geographic area for ATSC reception before a device is installed in a datacenter. This invention also solves a range of practical problems associated with ATSC reception in residential settings. By relocating signal reception to a professionally managed datacenter, it eliminates the need for rooftop or indoor antennas, avoiding the complexity of antenna installation, susceptibility to signal interference, and the physical risks of climbing or outdoor equipment exposure-including lightning strikes destroying property at the site struck by lightning or more importantly preventing injury or death from lightning strikes. The system simplifies ATSC access for non-technical users who may otherwise be unable or unwilling to configure TV tuners, antennas, or networked DVR devices. It provides consistent, high-quality signal capture regardless of home geography, terrain obstruction, or building material limitations. By integrating this with secure remote access and address-based eligibility, the invention makes local TV streaming more reliable, accessible, and safe.

A method and system for operating a datacenter that allows compliant remote access to geographically restricted ATSC television signals is provided. The datacenter hosts user-owned devices, which are installed only after verification that the applicant's physical address is within a legally permitted geographic region. The system provides power, network connectivity, and optionally, an ATSC antenna feed to each device. Ongoing address verification and policy enforcement ensure compliance with regional broadcast restrictions, enabling remote access without retransmission licensing by treating each device as a personal reception unit. The system may further support a group addressing mode, wherein one applicant device tuned to a specific channel generates a video stream that is encrypted and transmitted to multiple other verified members within the datacenter. The encrypted video is inaccessible to the datacenter operator, and a conditional access system distributes decryption keys only to eligible users located within the broadcast region. The high-efficiency group addressing architecture enabled by a network distribution element within the datacenter. A single user-owned device (Owner Device A) receives an ATSC broadcast, encrypts the video stream with a group key, and transmits the encrypted stream to a multicast-enabled switch or distribution server. The group key management and delivery of the content encryption key to a group is preferably performed in a group member owned device but may also be performed by the datacenter operator.

A “member” of the datacenter refers to an individual who has completed address verification and account registration, and who is granted authorized access to install the device they own into the datacenter infrastructure. Members include owners of physical reception devices hosted in the datacenter, or individuals accessing group-addressed streams from shared devices via encrypted key authorization, or trial users granted temporary access through address or address verification, physical presence or app credentialing. Trial user temporary access will be for a limited amount of time subject to address verification as described herein. Trial user temporary access provides device ownership to the trial user, or allows a user owned device to be installed into a datacenter subject address verification as described herein.

With group addressing one owner's device sends an encrypted video stream to hundreds or thousands of other user-owned devices (e.g., Member Devices 1-1000), each of which has previously received the group decryption key from the conditional access system. All devices decrypt the video locally and independently for playback. The routing of the one owners' device to many other device owners watching the same channel is performed at the network layer (in a switch or router or network element) at any location without infringing copyright ownership because the copyrighted material is encrypted. Network routing of one owners' device output to multiple datacenter members uses datacenter membership data allowing only authorized datacenter users with validated addresses to access the encrypted video. Group address routing outside the owners device reduces the cost and complexity of the streaming requirements for an owners device while preserving copyright owners copyrights. Importantly, the encrypted stream is never decrypted by the datacenter operator or switch or network routing element. This ensures legal compliance and content protection while achieving energy savings.

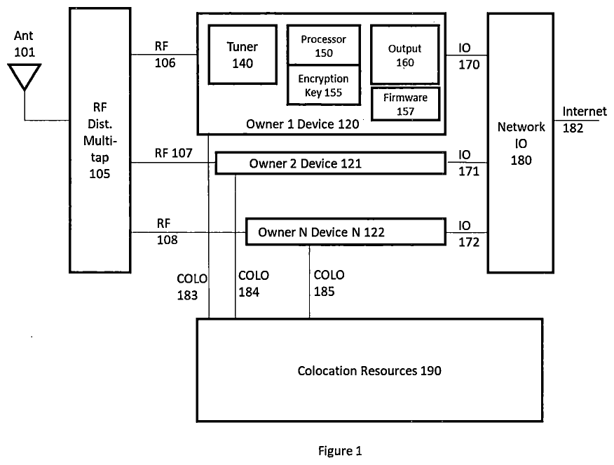

Referring to FIG. 1, Device 120 is any form of device that can receive TV signals sent over the airwaves using standards such as ATSC 1.0 or ATSC 3.0 in the USA. The inventive ideas of this invention apply to other types of digital TV signals such as DVB-T Terrestrial transmissions, DVB-S or similar Satellite transmissions, ISDB-T transmissions and any other form of video transmission.

Devices such as Device 120 are owned by individuals and the devices are installed in a datacenter, colocation space or colocation office. Colocation space is rented to the owner of the device. The colocation center for Owner Devices will be referred to as a datacenter, colocation facility, colocation office or colocation space.

The datacenter or colocation office is typically in a location that has strong reception of the TV broadcast signals in the broadcast area served by the TV stations broadcasting TV channels. The colocation space will have one or more antennae, adequate lightning protection, and an environment that protects owner devices from overheating, static electricity, power surges, constantly updated computer/device/network security protecting the device from hackers and other physical or virtual attacks or issues that can damage or destroy the Owner Devices, or provide attack points for hackers to attack the owners device or data contained in the owners device. The colocation center also provides a network connection for the Output 160 port of the Owners' Devices (120 . . . 122).

Before an Owner Device (e.g. 120) is accepted into the datacenter and connected to an antenna 101 and network 183, the owner is subject to one or more physical address verifications to verify the owner lives within the broadcast area for the given antenna 101 location. Additional optional physical address verifications may be performed periodically by the colocation center housing owner devices to make sure the owner of the device provided to the colocation facility did not move and is still in the geographic broadcast TV area for the locally broadcasting TV channels. The physical address checks can be supported by network IP address checks (or similar) wherein when the Device Owner accesses their device housed in the Data Center from an IP address in the given broadcast area for ATSC TV channels this is logged in the Device Owners' account providing proof that the device owner is entitled to enjoy the ATSC TV channel in that area. The GPS coordinates for the applications used by the device owner to play the content can also be tracked to verify the owner is legally entitled to access the content. A device owner may use any form of video player device with a display such as a smart TV, mobile phone, computer tablet, gaming console or any other device supporting playing audio and video content. The application used to play the content will use any device appropriate Operating System such as Android, Google TV, iOS, Windows, Mac, or other type of Operating System.

Antenna 101 is used to connect the input RF TV signal to the device. In one example, there is one antenna 101 only for a single device installed in the colocation center. This means for each owner device installed in the colocation center there is a unique antenna for only that one device. Should the colocation center have 500 devices collocated then there will be 500 antennae. In another example multiple Devices (120, 121, 122) are connected to a single antenna 101 through an RF Distribution Multitap 105 splitter where one antenna 101 feeds one or more Owner Devices.

When an owner of a device would like to place their device in the datacenter the owner will register with the datacenter. Registration includes the processes of physical address verification, optionally IP address verification, optionally periodic checking of physical or IP address, and optionally monitoring the IP addresses for each user accessing a user device.

Ownership—Device is owned by the individual and the device is supplied to colocation center. Colocation center does not have any form of software control of the Device 120. Colocation center supplies power and network connections, and optionally one or more antennae. In one example, owner provides device and antenna. In another example owner provides only the device. In another example, owner rents physical space for their device. Own may purchase a device on installment payments. In this patent application colocation center or datacenter or similar term will be used to described a location that supplies an antenna feed, power, and network connection to a plurality of devices owned by individuals. It is envisioned that datacenter or colocation center or similar location will be supplied by an independent datacenter operation, optionally a cable company, landscape company, power or water utility company, a service company, a mobile phone company, alarm company, an Internet Service Provider (ISP), a satellite TV provider, or any other type of company. In some cases, such as with an ISP or cable company the address verification described below will be part of the installation process for ISP, cable company, telephone company, service company (alarm or similar), satellite company, or other company and will be logged in the owners account for geographic validation for the owner's right to have the owner hardware installed in a datacenter. In the event owner moves or cancels a services (such as a broadband connection) other than the datacenter colocation of owner hardware an additional address verification maybe required based on owners action such as cancelling alarm service, or trash service or any other type of service.

The colocation center legal agreement or colocation agreement is associated with registration and usage for the datacenter includes one or more of the following provisions or steps or agreements with the owner:

### An Address Statement Declaring a Device Owners Physical Address.

One or more address verifications verifying that the Device owner lives in an area covered by the broadcaster and is entitled to receive the TV channels received by the antenna connected to the Owners Device. Periodic address re-verification is performed verifying the Device owner is still living in the broadcast region for the ATSC channels. Address verification and re-verification can be physical verification of any form (physical letter mailing, package or letter delivery address, drivers license, credit card billing statement, utility bill, lease agreement or other document). In another example the IP Address for communicating with an Owners' application or Owners' devices of any kind can be used to verify address or refresh owners address to assure owner is entitled to house their device in the datacenter. In another example a GPS receiver, or GPS is the device a user uses to play the content, or any other form of address verification can be used.

In another example, a device owner can supply their physical address from a drivers' license or credit card or electric bill or similar at the time of registering the device for colocation. The colocation center will optionally mail using the United States Postal Service (or a similar service) a proof-of-address letter including a unique code to the device owner supplied address in the broadcast area for the collation center. The device owner will have a short period of time (five to fifteen days for example) to enter a code printed on the proof-of-address mailing letter such that the physical receipt of the proof-of-address mailing is used to verify physical mail reception at the device owners provided address. In the event the device owner does not enter the proof-of-address code contained in the proof-of-address mailing the datacenter connection will be terminated or connection will be reduced and a notification sent to the device owner. In another example if the device owner cannot provide an address in the broadcast TV service area the owners device will not be installed in the colocation center, or if installed will be removed. In another example, when the device owner does not validate their address the datacenter operator will provide reduced or limited access to some or all of the ATSC channels Datacenter operator in one example has software installed in the owners device that works with the software in the owners device to limit channels received by the owners device on a channel by channel basis. In the limited access case, a message will inform the user that they have limited access until validating their address. Limited access may be restricted by the colocation center blocking access to the owners' device and presenting a message as to the reason and cure, that being validating their physical address. In another example, owner's device uses a network data encryption key and when this key is disabled or blocked due to failing to validate owners' physical address a message is presented on the owners player device use to display the ATSC TV channel. Group key or encryption key management is done in owner devices using datacenter supplied address validation data or in datacenter or network hardware. Regardless of the location where group management processing is performed the address verification processing reduces or cancels access to channels when address verification is not successfully performed.

In another example, a company such as a Cable Company or an Internet Service Provider or phone company or satellite TV can perform physical address verification when going to the device owners physical address during installation of any service such as mobile phone service or broadband Internet service. Depending upon a service providers interaction with a device owner different levels of address verification will be performed. When a service provider goes the device owners physical address the installation and operation of a service such as water or electricity at a physical address will be sufficient to validate the owners rights to copyrighted materials. In another example of address validation physical letter containing a validation code delivered by a service such as Federal Express, UPS, or Amazon, or similar to a physical address in one example will serve as verifying the device owners physical address and being qualified for installing owner device in datacenter after the device owner enters the code contained in the letter. Likewise, delivery of an authentication code in a letter to device owner and entered by the device owner and tracked by the datacenter will qualify device owner for their device or devices to be installed in the data center. The legal agreement between the Cable Company, ISP, phone company or satellite TV company will be modified to reflect the installation of hardware owned by an individual into the datacenter providers (Cable Company, ISP phone company, etc.) datacenter. Legal agreement for datacenter provider will have terms and conditions on the allowable hardware and firmware installed in the Owners device to prevent malicious firmware in a device from disrupting service. Datacenter operator may restrict allowable Owner Devices to only certain models of hardware with known secure and tamperproof firmware and security.

Owner will provide proof in any form acceptable to the datacenter owner, that the device owner owns the physical device being installed. Proof of address for a device owner can be in an acceptable form of select type such as drivers license, receiving physical mail with registration code for the device, or other form.

Colocation agreement will have terms regarding installing owner's device in colocation center under datacenter supplied colocation terms. Owner agrees installation will be performed by a colocation technician. Owner agrees they have limited physical access to their device in colocation center. Owner will agree that software in the owner's device will establish an encrypted connection to the owner's physical device and an application will be used for remote access to the device and for remote viewing of the TV channels received by the device. In one example an encrypted private connection is provided that is only accessible by the physical device owner or individuals with validated addresses by the datacenter operator. Each individual collocating their device receives an encryption key from the device that is used by the device owner to access their device over the Internet. Any form of encryption and access control can be used to provide a secure encrypted connection to the owners device housed in the colocation center. With the connection security keys managed in the owner's device the colocation center has no access to any data processed by the owners' device.

Owner agrees that they understand datacenter may access their device directly to change settings, or limit channels received in the owners. Colocation operator may power off a owners device in some situation.

A datacenter Registration Agreement may contain a provision where Device owner agrees to certain digital usage rights to preserve content owner Copyrights.

Registration agreement will also provide details on physically accessing the owners device in the datacenter. Datacenter access will be restricted, optionally scheduled with supervised physical access to owner device when requested by the Device owner. Restricted, scheduled and supervised owner access prevents colocation center visitors from accessing owner devices not owned by the person visiting the colocation center. There may be a charge for datacenter access to cover the cost of supervised visits to the datacenter.

Registration process will provide details on how the owners device can be returned to the device owner when requested by the device owner.

Datacenter agreement with owner will have a provision where owner agrees that if they move they will notify data center.

Owner will agree with datacenter operator that owner device may operate in a limited or restricted manner should address verification be delayed or not provided.

Owner further agrees to have hardware or software or firmware in their device and a physical device that meets all datacenter specifications.

Owner agreeing that they may have shipping charges for the return of their device should they decide to stop using the datacenter.

Owner agrees to abide by updated datacenter or colocation center terms and conditions.

Device owners will pay a monthly rental fee to have the devices they own installed in the colocation center. In one example of the invention, colocation center provides an antenna feed to device owner device. In another example, device owner's device has an internal antenna or antenna attached to the device owner's device and no external antenna connection is required from the datacenter operator. For devices that have built-in antennas that can receive a strong enough signal to receive the local TV channels without needing an external antenna the colocation facility will house the device without installing any external antenna. Colocation provides power and network connection and remote network access to device owners device.

Device will optionally have an HDMI video output for connecting to a TV set. Owner devices will have a wired or wireless network connection to provide a digital TV signal to remote viewing devices such as a tablet, mobile phone, computer, smart TV, Set Top Box or other device that can receive the digital TV signal from the owners' device.

Devices with HDMI video output will also have network access for remote access by the device owner so that device owner can watch local TV channels remotely from their devices over a network.

Device owner's device hardware may have video transcoding option performed within the owners' device to transcode video from one format to another. An example is ATSC 1.0 MPEG2 compressed video being transcoded to H.265 HEVC a more advanced form of video compress to save network bandwidth.

All software control and configuration of the owner device is performed with software contained in the owner's device. For example, one or more Graphic User Interfaces GUIs are included in device software used to configure the device and select channels to play, set reminders and other device related controls and processing. Colocation center does not perform any processing of the received TV channels and all processing is performed in owners device. Colocation center has no access to unencrypted audio or video data of any kind from the owners device.

Processor in the owner device receives Electric Program Guide (EPG) and sends the EPG data to an application the device owner uses to access their device. Datacenter does not process EPG data and does not have or need access to EPG data, clear video data, and other broadcaster data.

Datacenter provides network connection to Owners' device and one or more network related processing functions. Dynamic Host Configuration Protocol (DHCP) is one way Owner/User Device receives an IP address for remote access. Another way is a static IP address. Colocation center in one example manages network connections, IP addresses, ports used to access owner device or Network Address Translation (NAT), or other network related processing. In another example, device manufacturer assigned MAC address is used by networking hardware to provide remote access address information such as IP address. Other forms of providing network address (IPv4, IPv6, other) can be used to address Owner Device over the Internet. Datacenter will inform owner of the IP address of their device, or IP address and port number for their device, or a form or automatic address discovery will be built into the owners device such that the IP address is provided to the device owner automatically.

The owner device includes processing to encrypt the received ATSC TV channels and send the encrypted ATSC TV channel to the owner through datacenter network connection. As mentioned, ATSC TV unencrypted channel data is not accessible by datacenter and datacenter cannot decrypted Owner device data output.

Channel selection is performed by owner using a remote device application that is used to access the device using a device specific password known only to the device owner and people who received the device specific password from the device owner. Remove device application controls owner device in the datacenter, configures and controls owner device. Owners using an application, selects video channels to play, receives the video channels, decrypts the video channels and plays them on an owner device such as a Smart TV, mobile phone, tablet, Set Top Box, computer or another computer device.

For easy setup the Owners device will have a device unique barcode used to configure the device and pair an application to the device in the datacenter for configuration. QR code links device to remote user application for simplifying configuration. QR code terms of usage will have appropriate language when the usage of the QR code includes the sale of a device in the datacenter to an owner.

Owner device preferably has both an HDMI video output and a network connection, but at a minimum a network connection. Owner device HDMI connection is not used by datacenter and network interface is used by device to send encrypted data to the owner. Owner device HDMI connection can be used when they install their device in their home and connect their device to a TV set.

Owner Device will have one or more security processes managed by the device itself with updates provided by the device manufacturer and the owner. Colocation provider does not manage the channel selection and operation Owner Device. Colocation provides power to the device and network connection. Colocation center will make sure Owner Device's are protected by constantly updated and state-of-the-art security including Datacenter we provide will have:
a. Firewall protection blocking attackers from reaching owners STBs; Denial of Service and Distributed Denial of Service prevention preventing hackers from overloading the STB streaming capability and blocking service; Network port blocking. For example only a very limited number of ports will be open for Internet access allowing the datacenter to allow the requests from datacenter users using HTTPS and block requests from hackers who do not have a device in the datacenter; STB will be locked down with strongest Android security settings including preventing 3^{rd} party apps with viruses from being loaded; STB firmware cannot be updated preventing Android root OS attacks; all STB remote access will be disabled and data center operator will monitor Android security vulnerabilities and make sure even if OS has vulnerabilities the data center will provide additional network security that prevents hackers from exploiting the STB/OS vulnerability through blocking hacker access to the STB.

Managing Proof-Of-Residency is a critical element of this patent application and any form of verifying proof of residency can be used to verify that the device owner has a physical location in a broadcast TV area proving they are entitled to install equipment in the datacenter.

In this patent application address verification can be performed in a number of ways including by physical mail, IP address, a GPS USB or similar address location device, GPS location from Phone, or other GPS or other location providing device, or physical delivery verification to an address. An addition address verification method used to verify user is within the broadcasters region can be based on the physical location registered with a third party service provider such as a cable or satellite TV company such as Dish TV or Cox Cable, a mobile phone service provider such as Verizon or ATT, an electric power company, a utility provider such as a water company, a fire department, a police department, a delivery company or similar.
i. Another optional address verification method can use GPS or IP address verification during one or more of the following actions from device owner performing: Datacenter registration, Device configuration, Account management including billing address verification, Content playout,

Random periodic IP address checksPhysical presence in a location such as dropping off a data center address validation card at a local fire station or police department.

In one example of address verification an Address Verification Code (AVC) is sent to the Device owner in a letter delivered by the US Postal Service. In another example, a person goes online, prints an address validation letter and mails the letter to the datacenter where the post mark can be verified. In yet another example, the online printed address validation letter or code is dropped off at a local fire station. AVC contains a unique verification code used by the Device owner to verify they received the AVC code from a letter sent before, during, or after registration to the device owner. AVC code in one example will be mailed to the Device owner supplied address that is used when registering for datacenter service. Owner's device or datacenter networking system may restrict or terminate Owner Device access or operation if AVC code is not entered without a certain period of time. In case Device owner does not enter AVC code the Owner Device will be returned to the owner with an optional cost to return hardware. In addition, should owner decide to cancel the use of the datacenter the device will be sent back to the owner.

When the AVC code is not supplied by the owner a notice will be sent to the device owner indicating they need to enter the code. When AVC code is not supplied one or more restrictions may occur in the future including restricted playback until address is verified. Failure to verify address notifications can be sent to Device owner in any manner including email, sms text, voice call, US Postal Service or other type of delivery.

Owner Device may operate with network device access restricted by Datacenter. Remote Access for device control can be accessed by Device owner but streaming of encrypted TV channels will be blocked when address is not verified, or streaming may be at lower bitrate, or for restricted periods of time until AVC code is validated.

In one example of physical address verification a letter referred to as an Address Verification Mail (AVM) is sent to the device owner. The AVM contains an Address Verification Code (AVC) that will be supplied to datacenter to verify they received the AVM. Failure to provide the AVC code in a timely manner may restrict or cancel datacenter connections blocking the owner's device to operate without proper address verification.

In one example, a physical address+STB Serial Number is supplied to datacenter (DC), DC sends AVM mailer with code for only this STB registration. User logs into their STB and enters AVC. They can enter AVC online with datacenter.

Address verification can occur virtually using GPS showing Device owners location plus driver's license or credit card or similar.

Processing for sending an Address Verification Letter with an Address Verification Code (AVC) that is entered to prove person receives mail at the address they provided can be sent using any deliver service such as the US Postal Service, UPS, Fed Ex, DHL, or similar.

ATSC or similar broadcast signals from different geographic areas may overlap for device owners in certain areas. For example, a device owner in Trenton New Jersey with an omnidirectional antenna can receive TV channels from the Philadelphia and New York markets. Likewise, a device owner in Los Angeles may receive TV channels from Los Angeles, Riverside County, and Palm Springs. Software contained in the user application (IOS, Android, Roku, Web Browser, Smart TV (LG, Samsung, others), and other devices will provide a preference setting that selects the preferred primary channel source for a particular channel when the device owners' physical address according to the FCC can receive ATSC signals from multiple broadcasters of the same or similar channels. For example, the ABC channel TV signal can be received from NYC and Philadelphia and the user prefers the New York City (NYC) channel. In this example, when the user application presents the channel lineup to the user, multiple channel sources for ABC will be presented and the user will select their preferred channel source (NCY or Philadelphia). An indicator that the channel is available from multiple sources will be provided in case the device owner would like more localized content from one of plurality of content sources. Multiple channel sources will be provided to a device owner when their physical address indicates that they live in a reception area serviced by two or more broadcasters of the same channel. The physical address will be mapped by one or more ATSC (or similar) broadcast coverage mapping services such where the device owners physical address is entered and the mapping website provides TV channel coverage details including channel call sign, network, channel number, and RF band such as VHF high or low, UHF frequency details. Another similar site provides channel coverage information for the Trenton New Jersey area receiving signals from both Philadelphia and New York. Using the FCC DTV maps assures the device owner that the channels they are receiving are channels within the broadcasters' broadcast coverage domain. Presenting the various channel source options will give the device owner their preferred source for news, sports, weather, and channel programs. In the above example, NYC and Philly, both of these sources will have the same channel but with different news, sports, weather, commercials, public announcements and even different TV programs throughout the day. ABC NYC may air one program at 2 PM, and ABC Philly a different program. In this example, news, sports, weather will be more centric to the broadcast location NYC or Philly even for the same TV channel ABC-NYC or ABC-Philly.

When there are multiple sources for the same channel from different locations, the device owner is presented an option to receive Emergency Alerts from one, two, or more cities extending the awareness of emergency alerts. Even when there are no overlapping channels, Emergency Alerts from multiple locations are aggregated and optionally presented to the device owner. For example, the device owner will be able to chose their TV market such as NYC, or Philadelphia or both, additional options will provide broader coverage such as East Coast, New England States, Mid-West states, a tri-state area such as New York, Pennsylvania, New Jersey, or other combined areas so that the device owner receives Emergency Alerts from the areas they are interested in. The source of the Emergency Alert such as NYC will be provided along with the Emergency Alert Text. ATSC standards based (or other standards based) Emergency Alerts such as ATSC A/321 and A/331 support will be included in the device owners STB. Being that the device owners' address was verified for a data center they are added in one example to a group member ship and not the general public. A group Emergency Alert will be sent to all owners who select an option for all Emergency Alerts on any channel. In this example, group members of a particular data center can set an option to receive all Emergency Alert Messages broadcasted on any channel in the broadcast area for example, all channels on broadcasters in the New York City area. Group members will receive alerts even if an individual members Set Top Box is not in use. Such group association not only increases data center members access to alert messages when their device is turned off, it also provides significant energy savings.

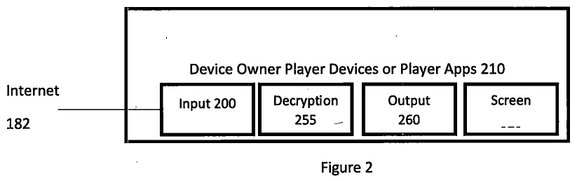

FIG. 2 provides an example of an application used by the device owner to access their device in the datacenter and securely play TV content on a TV, tablet, phone, computer, game console or similar device received by their device in the datacenter. Remote access between datacenter and Device Owner Player App (210) in one example is provided over an Internet connection 182. Owner device in datacenter FIG. 1 Device 120 feeds player device or player app 210 that has network input receiver 200, data decryption 255, output processing 260 that include a video decoder and video display support, and a screen 270 or output to a screen such as an HDMI connection not shown. Application 210 is used by the device owner to play content from their remote device such as a Smart TV with Internet connections such as an LG or Samsung TV, a mobile phone, tablet, game console or similar device.

Device Owner Player can be an application or device such as Set Top Box, Smart TV, PC, notepad, tablet, mobile phone or other device that can play content, and will also be referred to as a display device in this patent application.

Another invention element is providing a remote antenna for receiving ATSC signals feeding display devices in an owner's home. In the remote antenna aspect of this invention there will be two or more circuits comprising the Owners' Device to display ATSC video signals. One circuit will be essentially a tuner and demodulator receiving the ATSC RF and sending demodulated but not decoded ATSC data to the second circuit. The second circuit will typically be housed in the Device Owners location and will receive demodulated data from the remote antenna tuner. The second circuit will decrypt, decode into A/V images and display the ATSC video on an HDMI or DVI display or similar attached to the second circuit. The partitioning of the processing performed in the two circuits can be adjusted with the main concept being to keep the RF processing circuit in the Data Center and the video decoding and display processing in the second circuit outside the data center. In another example the Device Owners device in the datacenter will contain an HDMI encoder such that the Device Owners device in the datacenter performs all the audio and video processing necessary and outputs the HDMI or DVI video to an additional circuitry that converts HDMI to a compressed video format is sent out of the data center. Throughout this patent application the reference to a display device can be any form of device that can receive data from the remote antenna and decode the remote antenna data into video and display the remote antenna data. Examples include Smart TVs from Samsung, LG, and others, Android TV sets, Set Top Boxes, tablet computers, laptop and PC computers, game consoles and other computer devices. It is envisioned that display devices such as Smart TVs from Samsung, LG and others will support the processing needed to receive the demodulated ATSC RF signal sent from the Owners Device in the datacenter and contain the processing of the second circuit in the TV or device receiving datacenter feed over the Internet to decode and display the ATSC audio and video. In this case only the remote antenna and RF demodulation circuitry will comprise the Owners Device circuitry installed in the data center.

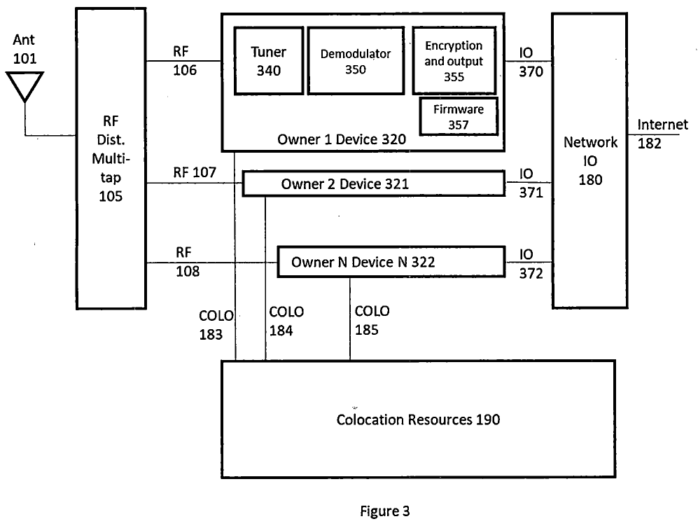

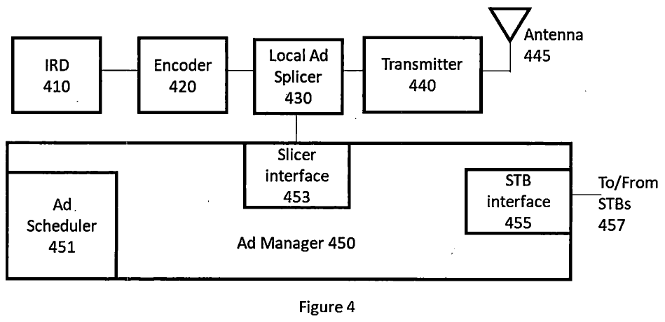

The remote antenna includes the RF receiver hardware including antenna, tuner, demodulator, access control for remote antenna access, and digital output from RF receiver hardware that is formatted for transmission over the Internet. A block diagram for the Remote Antenna is provided in FIG. 3. The RF tuner, demodulator, and digital output circuitry is similar to, or identical to a commercial ATSC tuner such as the Sony Semiconductor CXD2885GG-W LSI for automotive applications, or Sony CXD 6801GL or similar. The remote antenna sends demodulated ATSC data over the Internet to a device that decrypts, decodes, and displays the ATSC data.

The remote antenna device 320, like the owners device 120 in FIG. 1 is hardware that is physically housed in a location with ATSC excellent signal reception in an ATSC market such as New York City, Miami, etc. The location housing the remote antenna is similar to the datacenter described in other parts of this patent application but does not house the owners Set Top Box or similar device, rather is houses a subset of a complete STB. The remote antenna device 320 subset circuits are the RF section, and demodulator section of a STB or similar device. The remote antenna in a data center receives the local ATSC broadcast RF signal using owner hardware that is a subset of a full ATSC Set Top Box. In one example the owners hardware consists of an antenna, and tuner with demodulation circuitry and digital output to the Internet sending demodulated data over the Internet to a remote device that decodes and displays the signal fed from the owners remote antenna circuitry.

FIG. 3 provides a block diagram for the remote antenna aspect of this invention. Device 320 Encryption and Output 355 outputs a partially processed ATSC signal and output 355 requires further processing to decode the video data and display the ATSC data. In one example Encrypted and Output 355 sends an encrypted Transport Stream containing the ATSC demodulated digital data. Output 355 can send any form of partially processed ATSC signal including MPEG Transport Stream, ATSC ALP (Atsc Link Layer Packets) or similar digital data sent to a remote device (such as Smart TV, STB, mobile phone, tablet, etc. not shown) over Internet 182. Remote device receiving remote antenna from Internet 182 containing partially processed ATSC data stream is received in a remote device and the remaining ATSC processing steps are performed by the remote device.

Remote antenna output is sent over network to an owner device that includes an ATSC player (display) that completes the ATSC processing not performed by the remote antenna. Remote from the datacenter ATSC player or display decodes and renders ATSC3 video (HEVC or similar) and Dolby AC-4 (or similar) delivered from remote antenna over Internet. Remote device processing external to the datacenter may include for example receiving Owner Device IO 370 by a remote device using a network protocol such as UDP, ROUTE, HTTP, then decoding the compressed MPEG2 or H.264/H.265 video into a display format, processing the ATSC audio for output, decoding and displaying any Closed Caption data and displaying or recording the ATSC decoded video.

In the event timestamp adjustments or real time Physical Layer Pipes (PLP) adjustments or other timing related adjustments are required for proper decoding and playout in user device or player appropriate adjustments will be made in either the remote antenna 320 or user device 120. Depending upon system component processing it is envisioned by this invention that the location of various processing portions of the ATSC process can be performed in the remote antenna 310 or user device 120.

In one embodiment, each device installed in the datacenter is owned or leased by an individual subscriber, and the datacenter provides managed physical and network infrastructure as a hosting environment. The datacenter rents or licenses rack space, network access, and power to the device owner, ensuring individualized hardware tenancy. The relationship between the owner and the datacenter is contractual, where the datacenter acts solely as a facility provider and not as a content redistributor. This rental model reinforces legal compliance by maintaining user-specific access boundaries while leveraging the advantages of professional hosting. Temporary access such as a trial mode assigns exclusive device control to an individual for a limited timeframe. The user is treated as the effective device owner during this period. Ownership may later be transferred permanently or revoked, and compliance enforcement ensures uninterrupted access is only granted upon verification of long-term geographic eligibility.

In one inventive element of this invention the owner's physical device comprises two separate circuits that interconnect through a network to process the incoming ATSC signal. The two separate circuits process the incoming ATSC RF signal and demodulate the RF signal and sends the demodulated output to the second circuit that receives the demodulated data decodes the ATSC TV data for display on a TV, computer device, or any form of device that can render video on a screen, record video, or play audio. In this example one circuit will have the RF receiver and demodulate on a separate circuit with a network connection to a remote TV set that receives the demodulated RF signal and contains the circuitry to decode and display on the TV set (or other display device) the ATSC TV audio and video.

In another embodiment, the owner's device comprises two physically and functionally distinct components connected via a network. The first circuit includes an ATSC RF tuner and demodulation hardware that receives over-the-air signals and converts them into a digital baseband stream. This demodulated digital baseband stream is transmitted over a network connection to a second circuit, which may reside locally or remotely, and is responsible for decoding the ATSC video and audio for output. The second circuit includes a decoder and rendering subsystem, capable of displaying the decoded video on a television, computer, mobile device, or any other compatible display or recording platform. This architecture allows for the separation of RF reception and decoding processes, enabling flexible deployment in datacenter-hosted or hybrid viewing configurations. The digital baseband stream is optionally encrypted by the ATSC RF tuner demod hardware and un-encrypted by the second circuit.

In another example, it is envisioned that only a portion of the ATSC processing is done in a user device installed in the datacenter and the remaining processing required to display the ATSC TV channel is performed in a smart TV such as smart TV's sold by Samsung, LG, and others. Many smart TVs (not Set Top Boxes) include Application Program Interfaces (APIs) for streaming and broadcast TV. One example is Samsung Product Broadcast APIs built into Samsung smart TVs. The Samsung Broadcast APIs support devices with DVB/ATSC/ISDB tuners connected to an antenna. This invention envisions an extension to the Samsung Broadcast APIs to receive a partially or fully demodulated ATSC signal from an ATSC tuner owned by an individual and installed in the datacenter. In this example, the owners' device will receive an ATSC signal in the datacenter, perform a portion of the ATSC signal processing and send a digital output to the smart TV for further processing and display. In this example, ATSC RF Input is received by an owners' Tuner and Demodulator circuit in the datacenter and demodulated ATSC data is sent out of the datacenter in any format to a remote owner device such as a smart TV or Set Top Box or PC or mobile phone or similar that receives the demodulated ATSC data from the network connected to the datacenter and completes the required processing to display the ATSC TV channel on a display. In one example, an owners' ATSC tuner is housed in the datacenter and outputs demodulated data using as an encrypted MPEG Transport Stream or ATSC Link Layer Protocol (ALP) or similar. While a demodulated ATSC signal was used as an example, any form of partially or fully processed ATSC processing within the datacenter is envisioned, even HDMI screen capture and output to a remote player from an owners' device. In another example, a Sony CXD6801GL ATSC tuner output is sent digitally out of the datacenter for further ATSC processing in a smart TV, PC, mobile phone, tablet, Set Top Box, or similar device that receives the Sony ATSC tuner data and processes the data for display. The Sony (or similar) ATSC tuner output can be encrypted for further protection when leaving the owners device housed in the datacenter and sending partially processed ATSC signal data of the Internet.

In another example the remote antenna device 320 will send data to a Smart TV or similar device using the exact APIs supported by the Smart TV such as the Samsung Product Broadcast APIs. In this example the network output from Device 320 will have the same data format and protocol support as that expected by the Samsung Product Broadcast APIs, or similar APIs for other Smart TV from LG or others or other devices that contain APIs for receiving ATSC TV data.

An optional element to this invention when a Smart TV or similar device processes a portion of the ATSC TV channel, is that the Smart TV API will include an authorization code required to process the geographically restricted ATSC signal in the smart TV after address validation described in this patent application. In one example, an Allow ATSC Processing Authorization code will be sent to the smart TV during smart TV linking to owner device hardware installed in the datacenter. This linking process will enable the smart TV to receive and process the output of the owner's device installed in the datacenter. In one example, only an ATSC tuner (remote antenna device 320 of FIG. 3) will be housed in the datacenter, in another example a complete ATSC processing system with display output and HDMI capture will comprise the owner's device housed in the datacenter. Any form of network protocol can be used between the owner's device in the datacenter and the remote device used to display the ATSC TV channel including HTTP, HLS, MPEG DASH, RTP, RTMP, SRT or other network protocol.

To access remote antenna 320 and tune remote antenna support circuitry 340 and 350 user device will supply a user name and password to processing supporting remote antenna 320. Upon user's successful login to remote antenna 320 the remote user device (smart TV, phone, tablet or similar) will send tuner control data and receive ATSC video stream data or file data or similar data to remote antenna 320 to tune and stream an ATSC channel.

It is envisioned that there will be thousands of ATSC devices in a data center for thousands of verified device owners. Datacenter processing can reduce the amount of energy consumed by the thousands of individual devices by using one owner's device to feed all the datacenter users who are watching the same TV channel. For example, a data center has 40,000 devices installed and 4,000 users are watching the same channel at the same time. Instead of having 4,000 user devices consuming 16,000 watts of electricity one device can be used to feed the TV channel to the 4,000 users. In this example, the network hardware will in the datacenter will receive one channel feed from one of the user devices and distribute the channel to the 4,000 users. In this example, instead of using 16,000 watts of electricity, the one user device (ATSC STB) will feed datacenter networking equipment that will stream out the channel to the 4,000 users. The datacenter networking hardware to take in one channel and stream to 4,000 may require less than 500 watts of power. The results of such channel management and distribution will be a saving of over 15,000 watts of electricity. For 1,000,000 data center users watching 2 hours of TV daily a reduction of energy consumption in the range of 7 to 8 megawatts can be achieved. It is also envisioned that some ATSC TV channels will not allow such energy efficiency savings and when sending from a single user device to all the viewers watching the same channel is not allowed each owners device will stream on a one-to-one basis one TV channel only to the device owner.

ATSC 3.0 includes Digital Rights Management (DRM) protection for ATSC 3.0 TV channels. It is envisioned that ATSC 3.0 DRM processing will be included in any one or more elements described in this patent application including owner hardware in the datacenter, owner hardware remote to the datacenter, owner display device hardware or any other hardware used to display ATSC TV channels from the output of the owners' hardware in the datacenter. When necessary, owners display device remote from the datacenter may require an additional Internet connection to process the ATSC DRM.

This invention includes provisions for supporting ATSC 3.0 Digital Rights Management (DRM) with one or other various forms of DRM software integrated into the Owners' Device. When the entire Owners' Device is installed in the Data Center then the DRM is built into the device. When the Owners' Device has two circuits then the ATSC DRM is preferably contained circuitry containing the video decoder, display buffer and display output such as HDMI or DVI or similar.

Similar or identical address verification processing as describe in other parts of this patent application will be performed by the data center housing remote antenna. In the event address verification is not performed in a timely manner remote antenna will have one or more processing steps restrict or block remote antenna output or the user device 450 will operate in a limited mode. Limited mode when address verification has not be timely performed can range from completely blocking any output from remote antenna to only playing video with large watermark text across the decoded video stated “Address Verification Required” covering for example 90% or 100% of the display screen.

It is also envisioned that transcoding the video from the ATSC channel resolution to a different resolution will be optional and can be located in the Owner Device 120 or 320, or a cloud or external transcoder receiving data from Owner Device 120, or Owner Device 320 with additional processing to receive remote antenna 320 output and decode video for transcoding, re-encode video to different resolution or bitrate or format, send transcoded video back to Owner Device 120 or 320 and then Owner Device 120 or 320 sends the transcoded video across the Internet to the Owner and the Owners Player device containing a display or HDMI output or app or Smart TV.

In a further embodiment, the datacenter supports a group addressing mode, wherein a single applicant device tuned to a local broadcast channel generates a video stream that is encrypted before distribution. The encrypted video is transmitted across the datacenter network to other users whose addresses have been previously verified as within the designated geographic restriction. A conditional access system (CAS) manages cryptographic key delivery, ensuring that only verified members receive decryption keys necessary to view the content. The encryption process prevents the datacenter operator or unauthorized users from accessing the plaintext video. This model reduces redundant hardware usage and electrical power consumption while maintaining strict regional access compliance.

As mentioned above it is envisioned that one owner device in a datacenter will be used by multiple registered data center users selecting the same TV channel being played by the one owner device. For example, ABC channel 10 in the San Diego datacenter is received on one STB and multiple registered datacenter owners who want to watch ABC channel 10 will receive the channel from a single Set Top Box. This will be called Authorized User Groups (AUG). An AUG is a group of registered datacenter tenants who have their devices installed in the datacenter. To save significant amounts of power a single STB provides the channel feed to all the users in the AUG tuned to the desired channel they want to watch. The AUG processing is an added STB or cloud server software function that creates keys that are shared with the player or applications used by registered datacenter tenant to play the content. An AUG key is generated for ABC channel 10 and all other channels and is distributed during login by members of the AUG. In essence this processing is a Conditional Access System (CAS system) with group addressing similar to the CAS systems sold by Secure TV LLC, Verimatrix, Irdeto and other CAS software providers. The STB tuned to ABC channel 10 will encrypt the received video with a ABC channel 10 channel encryption key managed by the AUG software key manager. Authorized devices will request the ABC channel 10 decryption key from an AUG software key manager, the key manager will authenticate that the device or application requesting the ABC channel 10 key is an authorized registered datacenter tenant entitled to receive the ABC channel 10 key to decrypt ABC channel being sent from a single STB to all the AUG members requesting ABC channel 10. The single STB will receive, encrypt and send ABC channel 10 and the datacenter networking equipment will route the encrypted ABC channel data to all the authorized devices requesting to watch ABC at that time. Not only does this save significant amounts of energy it also prolongs the life of user devices installed in the datacenter by having them running in low-power standby mode or powered off. AUG process can be performed entirely in a single owner device, distributed across two or more owner devices, performed solely by the datacenter, or by a combination of one or more owner devices and datacenter, one or more owner apps and owner devices, one or more owner apps and one or more owner devices with or without AUG processing by the datacenter.

Another optional energy savings element of this invention is audio and video transcoding within the STB in the datacenter or a cloud based (external to the STB) transcode processing used to transcode the ATSC input video into lower bitrate or lower resolution video streams that will stream better on lower speed networks, such as mobile networks where the mobile device Internet bandwidth maybe limited compared to the Internet bandwidth for a broadband connection in a house.

Channels will be aggregated by the STB with priority ranking based on geographic location for the datacenter user. For example, there will be locations that will receive the same channel such as NBC from two or more different broadcast locations. The STB firmware channel mapping will work in one or more ways when deciding on selecting the same channel. In Mitchell South Dakota (zip code 57301) NBC is broadcast on ATSC Physical Channel 26.4. An antenna with long range signal reception in or near the Mitchell SD area may also receive NBC from Sioux Fall SD (zip code 57101) on ATSC Physical channel 21.3. The STB will have a priority mapping based on STB owners physical address. In the above example, the STB for an owner in 57301 zip code will use Physical Channel 26.4 for NBC, and offer 21.3 as a secondary feed for NBC. In another example, only 26.4 will be provided to the STB owner so that the local or nearest to Mitchell SD broadcast channel is displayed and others from more remote locations are blocked or offered as secondary channel options. While NBC from Sioux Falls (26.4) may be blocked, other channels not broadcasted in Mitchell SD such as The 365 (ATSC Physical Channel 21.5, Coz 21.6, Court TV 21.7, ION Mystery 21.8) from Sioux Falls will be displayed because the datacenter will have a long-range antenna to pick up available off air signals regardless of the TV channels signal strength. The antenna that can pick up long-range will provide more channels in a viewing area than might be broadcast locally. In another example, a station owner may prefer that viewers in the Mitchell SD area watch the Sioux Falls NBC channel all the time or at different times of the day.

Another energy savings aspect of this invention is the processing the identical data from a plurality of owner devices with hardware and processing optimization detecting identical data from a plurality of owner devices, creating a list of the source and destination owner device addresses for the identical data, processing one data set (not one per owner device), outputting the one processed dataset to the owner devices in the created list of source and destination owner device addresses. For example, 100 owner devices are tuned to the same channel and all 100 owner devices are outputting same channel data to a device such as DVR recorder or transcoder. Each will be discussed separately and the concept can be extended to other devices used to process owner device data.

Transcoder example: Transcoder input receive receives connections from a number of owner devices for transcoding input TV signal. Transcoder input receiver builds an input list and output list for each owner device sending the same data for transcoding. Transcoder input receiver will also verify data from the owner devices sending data for transcoding is identical to other owner data. Transcoder input receiver will then send only one input dataset (a single ATSC TV channel A/V data identical to the plurality of owner device data feeds) to a physical transcoding processing circuit to perform the transcoding function such as MPEG 1 Video transcoding to H.265 video format. Transcoder physical output will be for one input stream and transcoder physical output will feed an transcoded output data dispatcher that uses the created input/output owner device address list and output the transcoded output to each owner the device in the list. In this example, N input to I transcoder transcoding a single input of the plurality of identical data and output one transcoded output to an output distributor feeding the one transcoded output feed to N output devices providing energy savings. Likewise with other common audio, video, security and other processing functions can be managed in the above way. In addition, a single owner device can be configured to act as a single owner device feeding a plurality of authorized and registered datacenter users who have their owner devices installed in the datacenter.

Similar to the transcoding N input identical data reducer to a single feed to 1 transcoder processing and outputting one transcoded output to an output list dispatcher the same can be done for DVR disk storage. In the disk storage case N owner devices will be writing the same data to hard disk and the HDD identical input processing will detect the multiple identical disk data writes, and will write only one copy to the data to the physical disk and return the disk related data such as FAT or sector data for the one data write to a plurality of owner devices. Because the single copy of the data on disk is shared by a plurality of owner devices a single owner device will not have delete control over the physical sector where the single copy of data was written. It will not matter if the data is retained on the disk because each owner's individual device will remove the OS disk mapping data for their device only. The action to physically remove the actual data written on the disk can happen when all owner devices have deleted the data (a list of owner devices retaining the data is managed), or after a period of for example 180 days. In this example, 1000 owner devices recording the same TV program will result in nearly a 1000 to 1 savings in the disk usage and the amount of energy used in the writing process.

Owner devices in one example can also perform the N input to 1 processing function to N output data sending (dispatching) the single processed video to N user applications to save energy and increase datacenter and owner device efficiency. N input to 1 processing function to N output data dispatching to N owner devices can also be performed for live TV channel playout or recording where N owner's applications all want to watch the same channel and a single owner device is tuned to a channels and outputs the single ATSC TV channel AV feed to a 1 input to N output dispatching function. It is envisioned that the 1 input to N output dispatching function can be external to the owner device because the owner device will be outputting encrypted data only available to authorized datacenter owner applications that have the correct encryption decryption key and have had their physical address verified. N input to 1 processing, 1 input to N processing and similar group processing is an option and from a high level will be described as group processing. Copyright law is very clear that a service cannot send copyrighted material to the ‘public’. In group addressing the recipients of the same stream from a single owner STB is not the public. Rather the group receiving the same channel from a single STB are private members of the particular datacenter and not the public. Should there be copyright issues related to group delivery then a one-to-one relationship will be established between the device owner and their device without any group addressing. The preferred system design for the datacenter includes group addressing with 1-to-N, and N-to-1-to-N video processing. N-to-1-to-N processing is where N owner STBs send the same data to a processing element such as a cloud transcoder and the cloud transcoder performs identical data compression where N STBs sending the same data have N input network connections, followed by N-to-1 compression where the N identical data inputs are reduced to 1 identical data set, the 1 identical data set from N devices is processed, and the 1 processed dataset is output to N devices using 1-to-1 communications between the cloud transcoder and the N devices sending data to the cloud transcoder. N-to-1-to-N processing can be performed for any video operation such as transcoding, Digital Video Recording, STB PVR Personal Video Recording, network PVR, cloud storage, or any other video or audio processing.
a. Terms of the datacenter contract with the device owner will include the option to option into any one or more of the energy savings techniques described herein. Datacenter contract will indicate there will be no reduction to the owner device warranty when an owner device is used in energy saving mode, is actively used by many datacenter members, and is the active owner device that is active outputting data to a plurality of authorized datacenter users who have their devices in the datacenter.
b. In another example of a group addressing configuration, when a user device (e.g., User 1) is tuned to a specific channel (e.g., Channel 10) and that device's encrypted output is being consumed by multiple verified members, the system preserves stream continuity if User 1 initiates a channel change. Instead of interrupting the existing group stream, the device remains tuned to Channel 10 and continues serving the group, while User 1's personal viewing session is reassigned to another device already streaming—or switched to—Channel 20. This handover logic ensures uninterrupted viewing for group members and enables dynamic reassignment of devices based on collective viewer demand while maintaining encryption and individual device compliance.
c. Importantly, the system provides a legally compliant method for remote access to local ATSC television signals without requiring retransmission licensing or consent. Because each device is owned and controlled by the applicant, and is installed only after confirming the applicant's legal residence within the geographic coverage area, the system functions as an extension of the applicant's own personal antenna setup. Unlike centralized retransmission systems, the invention ensures that each user accesses only their individually owned device, located within a compliant market, thus avoiding classification as a retransmission or broadcast service provider.
d. Because each device is owned by a specific user and installed only upon confirmation of a valid local address, this system enables legally compliant access to geographically restricted ATSC content without requiring retransmission licenses. The access is personal, non-commercial, and equivalent to a user operating their own antenna at home, but hosted in a managed datacenter.
e. As part of the invention's compliance and operational framework, a backend management interface may be implemented to ensure continued enforcement of geographic eligibility and lawful use. This interface tracks applicant device status (e.g., online/offline, tuning behavior), logs results of initial and periodic address verification, and allows for automated or manual enforcement actions such as disabling network access to devices that fall out of compliance. The system may also record metadata such as access timestamps, IP activity, and device ID for audit purposes. By centralizing these compliance controls in a secure, administrative environment, the invention ensures that geographic restrictions are verifiable, enforceable, and maintainable over time without manual intervention. This infrastructure also enables scalable deployment across multiple datacenter regions while preserving individualized user access controls.
f. This model contrasts with prior art and failed legal approaches, such as the Aereo and Locast systems, which attempted to deliver local television over the internet but were deemed infringing due to shared infrastructure or lack of individual ownership and compliance enforcement. In the present invention, because the access is limited to the applicant's own hardware and address-specific verification is enforced continuously, the legal framework is aligned with individual reception rights.

Enforces geolocation compliance not just at onboarding but throughout the lifecycle of the service, which could be crucial for maintaining legal distribution boundaries (e.g., retransmission rights, DMA boundaries).
a. Another inventive aspect of this invention is the enhancement of traditional linear TV ads spots with higher valued targeted ad replacements. In TV advertising broadcasted TV ads offer broad reach but less precise targeting and measurement, while web-supplied ads to a video service provide advanced targeting, detailed analytics, and cost flexibility. Ad processing enhancements in this invention provides the broadcaster, affiliate, or both the option to replace broadcast TV ads with web-supplied ads (web ads). FIG. 4 illustrates a typical block diagram of a local TV ad system with inventive enhancements of this invention. The IRD 410 represents the input of a TV signal containing AD markers that indicate where local ads can be inserted.
b. Client Application Access for Remote Playback:

In one embodiment, the system includes a user-facing application designed for platforms such as iOS, Android, smart TVs, set-top boxes, and web browsers. This application enables verified users to remotely access their individually owned device hosted within the datacenter. Once authenticated, the application securely connects to the datacenter over the internet via a private or encrypted tunnel, retrieving live or buffered ATSC content directly from the user's assigned device. Because each device is user-specific and geographically verified, the application interface avoids any shared content architecture, maintaining compliance with retransmission laws and personal-use exemptions. The application abstracts technical complexity, presenting a simplified interface for channel selection, playback, and (if supported) encrypted DVR access. Integration with the network bridge and conditional access system ensures that encrypted content delivered through optional group addressing is decrypted only for users with valid access rights, based on geographic eligibility and subscriber account linkage. This enables consistent, legally compliant access across a range of modern devices with no antenna, tuner, or technical setup required at the user's home.

### End-User Application Access to Hosted Devices

c. In a further embodiment, the invention includes a cross-platform software application compatible with mobile devices (iOS and Android), smart TVs, connected set-top boxes, desktop browsers, and similar endpoints. This application allows the subscriber to remotely access and control their individually owned device hosted in the datacenter. Upon successful authentication using a secure login method—such as a password, hardware token, or biometric credential—the application establishes an encrypted communication tunnel to the datacenter.

The system links the subscriber's account to their verified, legally located device. Through the application interface, the user may select available ATSC broadcast channels, initiate playback, pause or time-shift content (if DVR storage is supported), and optionally access encrypted shared streams delivered via the group addressing feature. In such group playback scenarios, the application uses a conditional access module to request and decrypt content keys based on verified eligibility, ensuring that only users with authorized addresses within the DMA can view content.

The application is designed to operate with minimal setup, making ATSC streaming accessible to users without antenna installation, tuning knowledge, or networking skills. Playback occurs via direct connection to the user's datacenter-hosted device or through encrypted shared streams compliant with content protection and licensing constraints. The system architecture ensures that no unencrypted broadcast signal is ever made available to the datacenter operator or intermediary, thereby maintaining a legally compliant, user-owned access model even on remote consumer devices.

In certain embodiments, the system includes a time-limited address verification process to ensure that an applicant device is authorized to receive geographically restricted ATSC television signals. During a predetermined time period following initial installation or deployment of the device, network and power connectivity may be provisionally supplied to the device to allow for activation and verification procedures.

If the verification of the applicant's physical address is not successfully completed within this time window, the system may respond by either limiting the functionality of the device (such as disabling ATSC signal access or restricting network throughput), or by fully terminating the network and/or power connection to the device.

This enforcement is preferably implemented through firmware embedded within the applicant device or through hardware components, such as network controllers or power gating circuitry, that are under the remote control or supervisory authority of the datacenter operator. The firmware may periodically check in with a central control service or await a signed confirmation signal, and may enter a restricted or locked state upon failure to receive such confirmation within the allowed timeframe.

This architecture ensures that only verified users within the authorized geographic area can continue to access ATSC signal services via the datacenter, while preserving operational control at the infrastructure level. Furthermore, because the enforcement mechanism resides within firmware or hardware managed by the datacenter operator, the risk of tampering or unauthorized circumvention by the applicant is significantly reduced.

The verification module is responsible for determining whether a user requesting datacenter access for a device is physically located within a predefined geographic region authorized to receive over-the-air television signals managed by the datacenter system.

In various embodiments, the verification module may be implemented in software, firmware, hardware, or a combination thereof, and may execute as part of a centralized control service within the datacenter or as a distributed process spanning multiple components. The verification process may include, but is not limited to: validating a user-provided physical address against a list of permitted regions (e.g., designated market areas or FCC-defined broadcast zones); cross-referencing the user's address with geolocation databases, postal service records, or third-party verification services; optionally generating and sending a verification code via a trusted delivery service (e.g., United States Postal Service), requiring the user to enter the code through an activation portal; utilizing billing address, IP geolocation, or device-based GPS as additional or alternative verification inputs; storing the verification result in association with the user's device ID or account profile for subsequent access control decisions. The verification module may be further configured to determine whether a user's access should be provisioned or restricted based on the outcome of the verification process. In certain embodiments, the module controls a network access gateway, such that remote access to the device is only enabled following successful verification. The verification module may also trigger alerts, retry procedures, or time-limited provisional access while awaiting final address confirmation. Integration with a monitoring module or revalidation system allows for periodic re-checks to maintain continued access compliance.

In some embodiments, the system includes a group address channel manager module configured to monitor and manage channel assignments across devices in the datacenter, with the goal of optimizing bandwidth, minimizing redundant tuning, and preserving uninterrupted viewing sessions for groups of users accessing the same television channel.

Access to the datacenter system and its services is strictly limited to registered members whose physical addresses have been validated and confirmed to lie within one or more predefined geographic regions authorized to receive the associated broadcast signals. These users are not members of the general public but are instead part of a closed group of verified individuals who meet the geographic and system membership criteria defined by the datacenter operator.

In some embodiments, the system includes a group address channel manager module configured to monitor and manage channel assignments across devices in the datacenter, with the goal of optimizing bandwidth, minimizing redundant tuning, and preserving uninterrupted viewing sessions for groups of users accessing the same television channel.

Access to the datacenter system and its services is strictly limited to registered members whose physical addresses have been validated and confirmed to lie within one or more predefined geographic regions authorized to receive the associated broadcast signals. These users are not members of the general public but are instead part of a closed group of verified individuals who meet the geographic and system membership criteria defined by the datacenter operator.

The group address channel manager module is responsible for detecting when a device assigned to a specific member is currently serving as a source of a shared channel feed for multiple other members. If the owner of such a device requests to change channels, the module intercepts the request and initiates a reassignment protocol. Rather than retuning the owner's device and interrupting service to the other members, the module maintains the device's tuning state on the current channel and redirects the owner's session to a second datacenter-hosted device already tuned to the newly requested channel.

This redirection is managed within the closed membership network and may involve updating session routing records, generating secure handoff tokens, and authorizing the session switch through the system's authentication layer. All content and session routing decisions remain restricted to verified users with established geographic rights.

The group address channel manager module may be hosted on a centralized server within the datacenter, on one or more owner-provided devices, or may be distributed in a cloud or peer-to-peer configuration, wherein channel allocation and reassignment decisions are made collaboratively among participating devices under coordination protocols.

The module also enforces policies determining how long the original device remains tuned to the shared channel, such as maintaining the stream until all group viewers disconnect, until a timeout expires, or until an alternate device can be reassigned to the group. In some embodiments, the module further coordinates with encryption systems to ensure that all shared feeds are protected and accessible only to eligible datacenter members with valid decryption credentials.

The group address channel manager module described herein may be deployed in a variety of architectures. While certain embodiments involve a centralized implementation within the datacenter's core computing infrastructure, alternative configurations are also contemplated.

In some implementations, the group address channel manager module may be hosted on one or more user-owned devices participating in the system, with secure control protocols enabling the devices to contribute to or manage channel assignment decisions, subject to verification and access policies. In other embodiments, the module may be implemented in a distributed computing environment, such as a cloud-hosted service, an edge compute layer, or a peer-to-peer mesh network in which multiple devices or microservices collaboratively perform session tracking, channel state management, and reassignment logic.

These distributed implementations may include coordination protocols to ensure synchronization of channel state, fault tolerance, and enforcement of geographic restrictions. All such variations are within the scope of this disclosure, and the functional behavior of the group address channel manager module remains consistent regardless of deployment model.

In some embodiments, the system further includes a video storage manager, which is configured to coordinate access to television content that has been recorded and stored by user-owned devices participating in the datacenter system. This functionality enables a form of group-based digital video recording (DVR), wherein verified members of the datacenter are allowed to access, stream, or replay stored video content from devices owned by other members, provided that access permissions and geographic eligibility conditions are satisfied.

The video storage manager maintains metadata describing the location, content type, recording time, and access rights associated with each stored video asset. When a user initiates a request to view stored content, the video storage manager identifies eligible storage devices within the system-such as devices belonging to other validated members-that contain the requested content and are authorized to share it under system policies.

Access to shared stored content is restricted to members of the datacenter who have undergone address validation and who are authorized to receive the requested programming based on geographic constraints. The sharing of stored content is conducted within a closed, authenticated membership network, and is not made available to the general public. Playback streams may be encrypted, and access tokens may be issued only to authorized recipients under session-based or identity-based controls.

The video storage manager may also coordinate playback synchronization, resolve conflicts between concurrent access sessions, and manage retention or quota policies associated with group-based recordings. In some configurations, the storage manager may offload or replicate recorded content to datacenter-controlled storage infrastructure for reliability or high-availability playback, while still preserving user-level control and attribution for content recording rights.

In distributed environments, the video storage manager may operate as a coordinated module across multiple devices or cloud components, using distributed indexing and peer discovery to locate and authorize access to stored content.

### Redundant User-Owned Device for Failover Channel Continuity

To ensure uninterrupted access to television signals within the datacenter system, the architecture may optionally incorporate redundant user-owned devices that serve as failover sources for specific channels. In particular, when a group of datacenter-validated members is viewing a particular television channel sourced from a primary user-owned device, the system may identify and maintain one or more secondary user-owned devices that are also tuned to the same channel and are eligible to act as backup sources.

If the owner of the primary device cancels their service, deauthorizes their device, or otherwise becomes ineligible to participate in the datacenter system, the system may automatically promote one of the redundant backup devices to become the new channel source. This transition is managed by a channel manager or session controller module and is designed to be seamless from the perspective of the remaining viewers. Playback sessions continue without interruption, and channel continuity is preserved for all remaining group members.

These redundant devices are subject to the same address validation and membership eligibility requirements as primary devices. The selection of backup devices may be based on factors such as device availability, tuning status, geographic proximity, signal quality, and trust score within the datacenter system.

In some implementations, the system may pre-register eligible backup devices for each active group-viewed channel, maintaining live health and tuning state information to enable rapid failover without the need for re-tuning or user intervention. This failover model enhances system reliability, particularly in distributed environments where content availability depends on participation from user-owned hardware.

### Remote Access Application and Conditional Access System

In certain embodiments, the system includes a software application configured to allow datacenter members to remotely access and control their user-owned devices hosted within the datacenter. The application may be implemented for use on a variety of platforms, including mobile devices (e.g., smartphones and tablets), smart televisions, desktop computers, laptop computers, and streaming media players.

The application enables a verified subscriber to remotely initiate playback of ATSC broadcast content received by their device hosted in the datacenter. This includes real-time tuning, playback control (pause, rewind, fast forward), and, where authorized, access to group-addressed video streams shared among geographically validated users.

The application operates in conjunction with a conditional access system (CAS), which enforces secure access to broadcast content. The CAS is configured to validate that the subscriber's geographic location remains within an authorized broadcast region and that their membership and address verification status are active. Once validated, the CAS delivers session-specific or device-specific decryption keys that allow the application to decrypt ATSC content, including content distributed through group addressing mechanisms.

The CAS may support both unicast and multicast distribution models, and may enforce time-bound or session-bound decryption policies. In some implementations, the application is also capable of rendering both live and time-shifted content, including content sourced from DVR-capable user-owned devices managed by the system's video storage manager.

The application may also provide a user interface for device monitoring, channel selection, access to past recordings, membership status review, and re-verification processes. Communications between the application and the datacenter are encrypted using secure protocols (e.g., TLS, DTLS), and user authentication may be enforced via username/password, token-based systems, biometric login, or multi-factor authentication mechanisms.

The application may also provide access to recorded content stored on the user's own device or on other eligible member devices participating in a shared DVR system. In certain implementations, the application supports peer-to-peer discovery and access, allowing the system to locate and stream recorded content from other user-owned devices within the datacenter that are authorized for content sharing. The video storage manager or group address channel manager module may coordinate this discovery process and enforce viewing rights, storage limits, and transfer policies. This enables distributed DVR functionality, where multiple geographically verified devices can collaboratively serve stored content to one another, under the supervision of system access controls and encryption layers.

In certain embodiments, the datacenter system supports peer-to-peer (P2P) content sharing between verified user-owned devices that are hosted within the datacenter or are otherwise connected via secure network links. To ensure secure operation of the peer-sharing environment, the system includes a peer access control module, which governs the discovery, authorization, encryption, and usage of content transmitted between peer devices.

The peer access control module is responsible for determining whether a device is eligible to participate in P2P content sharing based on criteria such as: verified membership and address validation, content rights eligibility (e.g., geographic entitlement), device integrity (e.g., firmware version, trusted execution environment status), historical behavior (e.g., trust score, error rate, session consistency).

When a verified member device requests playback of recorded content not stored on its own system, the peer access control module may initiate a peer discovery process, which searches the network for other eligible member devices currently hosting a valid copy of the requested content. Discovery may be performed through a decentralized index, a distributed hash table (DHT), or a controlled registry managed by the datacenter system.

Upon locating one or more peer devices with matching content, the module performs a mutual authentication step between the requester and content host. This may involve exchanging signed tokens, verifying digital certificates issued by the datacenter operator, or completing a secure handshake using established protocols such as TLS or DTLS. Each session is cryptographically isolated to prevent unauthorized access or replay attacks.

Once authentication is successful, the system establishes a secure transmission channel between the peer devices. All video and metadata transmitted between peers is encrypted, either using end-to-end encryption with session keys negotiated per transaction or by applying transport-layer security with key rotation policies enforced by the datacenter or content manager.

The peer access control module additionally: Enforces digital rights policies including maximum concurrent views, time-based access limits, and revocation conditions; Maintains audit logs of peer content transactions for compliance and security review; May issue short-lived access tokens or capability keys specific to the requesting user's verified rights, geographic location, and session duration; Detects and responds to unauthorized access attempts, excessive retries, device impersonation, or firmware tampering.

In distributed implementations, peer-to-peer access control may also be federated across a mesh of cooperating modules, where each participating node enforces a local access policy while synchronizing with the datacenter's global policy framework. This enables robust scaling and fault tolerance while maintaining content security and regulatory compliance.

The module may also interface with the conditional access system (CAS), such that peer-transmitted video is subject to the same geographic validation and key-based decryption policies as content sourced directly from the original user's device or from datacenter-managed group-address feeds. In some configurations, decryption keys issued for peer-shared content are tied to session identity and playback device fingerprinting, preventing redistribution or unauthorized playback outside of the designated application or user context.

### Secure Group Access to Shared Channel Feeds

In certain embodiments, the system includes a secure access system that supports not only one-to-one authenticated access between a verified user and their own device, but also group-based access to shared channel feeds originating from user-owned devices hosted in the datacenter.

When a device owned by a verified member is tuned to a particular ATSC channel, and that channel is requested by other geographically validated members, the secure access system may permit multiple session connections to the same device. These connections are authenticated individually, but routed collectively to the same underlying channel feed, subject to verification of geographic eligibility and membership status.

The secure access system may route group access traffic using several methods, including:

Direct IP routing, if permitted by the datacenter network architecture and device exposure policy; Proxy routing, wherein the datacenter acts as an intermediary endpoint for session requests and forwards them to the source device while preserving user session identity and authorization context; Transparent access bridging, where the datacenter dynamically enables or disables passthrough routes to user-owned devices based on the requesting user's current account status, authorization, or policy restrictions.

To manage shared access securely, the system may use session-based or identity-based tokens issued by the secure access system, which allow each viewer to decrypt the stream independently through a conditional access mechanism. The system ensures that only members with validated geographic rights can join a shared session, and it may restrict the number of concurrent viewers based on policy rules, resource availability, or content licensing limitations.

In some implementations, the secure access system works in conjunction with the group address channel manager module, which tracks active group viewing sessions and optimizes device assignments to ensure consistent channel availability, failover, and continuity during dynamic session reassignments.

Audit logging, usage tracking, and revocation capabilities may be included to ensure compliance with access policies, including detection of unauthorized redistribution, spoofed session attempts, or circumvention of regional restrictions.

In some embodiments, the secure access system further supports peer-to-peer (P2P) group access, wherein a verified user may access a channel feed or recorded content directly from another member's device, without the stream passing through a centralized datacenter proxy. In this model, the secure access system facilitates peer discovery, authenticates each party, and coordinates session handshakes, but the video data is transmitted directly between peer devices using end-to-end encryption.

The P2P connection is permitted only when both the content-hosting and requesting devices are part of the same closed, geographically validated membership group. Routing logic may select between centralized and P2P paths based on network conditions, policy enforcement, latency, or load-balancing preferences. All peer-based access remains subject to the same conditional access system, and decryption is allowed only with session tokens issued to verified members. The system may also support hybrid peer-assisted delivery, where a stream is partially distributed across multiple peer sources for redundancy or bandwidth optimization.

### Encrypted Stream Replication and Group Decryption

In some embodiments, the system supports a one-to-many content delivery model in which a single encrypted video stream generated by a user-owned device is distributed to multiple verified members of the datacenter network. This is accomplished without requiring the datacenter operator or its infrastructure to access, decrypt, or inspect the video content itself.

When a user-owned device is tuned to a specific ATSC channel, it may generate a compressed and encrypted output stream, using a group encryption key or per-session encryption scheme. This stream is then routed through a network element or stream replication service within the datacenter. The replication service is configured to duplicate the encrypted stream and distribute it to all other verified users who have requested access to the same channel and are authorized under geographic and account validation policies.

The datacenter does not decrypt or transcode the video stream. Instead, each authorized recipient uses a group decryption key or session-based decryption token that is only accessible to verified members of the datacenter. The key may be distributed through the system's conditional access system (CAS), and may be bound to specific attributes such as: the recipient's validated address, active session status, playback application integrity, or device fingerprint. This architecture enables efficient one-to-many delivery (e.g., multicast-style replication) while preserving the security and legal isolation of the content source. Since the datacenter merely replicates encrypted traffic and does not participate in decryption, this model supports compliance with privacy requirements and may offer additional protection under legal frameworks that distinguish passive transmission from content retransmission.

In some configurations, the system may use hardware-level or virtualized network appliances to perform stream duplication at the packet level. Key management infrastructure may support key expiration, rotation, revocation, and reauthorization in response to user login status or security policy changes.

### Datacenter-Based Addressing and Routing System

In some embodiments, the system includes a datacenter-based addressing and routing system designed to manage scalable, secure, and geographically organized access to user-owned devices hosted within the datacenter. Each user-owned device is assigned a unique network routing context, which may include a dedicated network port, a statically mapped network address, or a dynamically assigned NAT (Network Address Translation) entry.

The system provides region-specific DNS (Domain Name System) endpoints to client applications. When a user launches the application to access their device, the application connects to a DNS address associated with the user's verified region or datacenter location. This domain resolves to a datacenter ingress node or load balancer responsible for managing the session setup for that region.

Upon successful authentication of the client application, the datacenter dynamically establishes a network path to the corresponding user-owned device using one of several addressing strategies: Preassigned Port Forwarding: If the user-owned device is assigned a static port mapping, the datacenter routes inbound traffic directly to the device's unique port via a firewall or load-balancer rule. Temporary NAT Address Assignment: For dynamic environments, the system may allocate a temporary internal IP or NAT address to the user session and forward traffic to the device based on an ephemeral session mapping that expires upon logout or timeout. Proxy-Linked Connection Manager: In some implementations, a connection manager service creates a dynamic proxy link between the authenticated client application and the user-owned device. The proxy link is established based on the application's authenticated identity, session tokens, and device pairing records, and may include encryption, bandwidth throttling, and activity monitoring features.

The routing system may operate in conjunction with a session manager, network access controller, or reverse proxy framework to ensure secure and isolated communication paths. All traffic routing decisions are performed only after successful identity validation, ensuring that no datacenter-level port exposure or device access is possible without proper credentials and session authorization.

In configurations supporting group access or P2P models, the addressing system may also maintain secondary mappings for session replication, where additional viewers are connected to the same user-owned device through virtual ports or authenticated proxy routes, without modifying the original connection parameters of the device owner.

The system may further support rate limiting, DDOS protection, firewall integration, and session expiration policies, and may log all connection events for security auditing and system analytics.

### Group Addressing Port Linking System

In some embodiments, the system includes a group addressing port linking system, which enables a single encrypted video stream—such as a channel feed received and encoded by a user-owned device hosted in the datacenter—to be securely delivered to multiple verified recipients. Rather than establishing a dedicated network session for each viewer, the system associates the encrypted stream with a shared logical port within the datacenter.

This logical port acts as a multipoint distribution endpoint, through which the stream is replicated and transmitted to authorized users. The shared port is not publicly addressable, but is mapped and controlled internally by the system, and is accessible only through authenticated sessions initiated by validated users.

Access to the stream through the shared logical port is governed by a group access table, which maintains a list of eligible recipients. Each entry in the table is added only after the system has verified that the recipient: has an active account in good standing, has completed physical address verification and falls within the geographic broadcast rights zone for the channel, is a recognized member of the datacenter's closed group of authorized users.

When a new user requests access to the channel, the system evaluates the eligibility criteria. If validated, the user's session is added to the group access table, and a decryption key—either a group-wide key or a session-specific variant—is issued to the user's application through the conditional access system (CAS). The group key allows the encrypted stream to be decrypted locally at the user's device or app, without requiring decryption at the datacenter layer.

The group addressing port linking system may also include: dynamic key rotation support, session expiration policies, per-session logging for audit and compliance purposes, and optional stream tagging or watermarking mechanisms to trace misuse.

This architecture reduces redundant video stream processing, enables efficient distribution to large groups, and preserves content security and regulatory compliance by ensuring that all content remains encrypted in transit and is decrypted only by authorized recipients.

In some embodiments, each device hosted within the datacenter is assigned to a single, verified user through a sale and permanent transfer of ownership. The system supports device onboarding scenarios in which a user: provides their own hardware (self-owned device), purchases a device outright from the datacenter operator or an authorized vendor, or is offered a device through a service contract that includes a final transfer of ownership to the user.

In all such configurations, the device is transferred by sale to the individual user, resulting in the user becoming the legal owner of the physical hardware. Once ownership is established, the device is registered within the datacenter system as permanently associated with that user's account.

The system enforces strict user exclusivity, ensuring that the device: is not shared, pooled, or virtualized across multiple accounts, is under the sole control of the individual account holder, and cannot be accessed or reassigned to other users without re-initiation of the ownership process.

To support this exclusivity, the system may apply hardware-level identifiers, cryptographic pairing, conditional access keying, and access control enforcement, such that only the account holder to whom the device has been sold is capable of initiating sessions, tuning channels, or decrypting content.

This architecture ensures that each device operates as a legally and technically distinct receiver, analogous to an in-home antenna and tuner, but hosted in a managed facility for improved performance and convenience. The sale-based ownership model distinguishes the system from multi-tenant or cloud-based streaming platforms, and supports regulatory and copyright compliance by maintaining the personal, non-public character of each device's operation.

### Device-Channel Streaming Map and Group Continuity Logic

In some embodiments, the system includes a device-channel streaming map, maintained within the datacenter, which tracks the current tuning status and stream assignment of each user-owned device. The map enables the system to associate active channel feeds with specific devices, and to manage group distribution of those streams to verified viewers.

When a user-owned device is tuned to a television channel and that stream is being accessed by multiple verified users within the datacenter system, the stream may be designated as a group-accessible feed. In such cases, the system may continue to stream the channel from that device, even after the owning user changes channels, logs out, or becomes inactive. This ensures that group viewers do not experience interruptions, and that content distribution remains seamless and continuous.

To support fault tolerance and load balancing, the device-channel streaming map includes primary and backup device designations for each active group-viewed channel. When multiple user-owned devices are tuned to the same channel and meet eligibility criteria, the system may promote one to primary status for encrypted group distribution, and maintain others as designated backups. If the primary device becomes unavailable due to channel change, device failure, service cancellation, or logout by the owning user, the system automatically fails over to a backup device without requiring reauthentication or re-tuning by the group viewers.

All streams shared through this mechanism remain end-to-end encrypted, and access is restricted to users listed in the corresponding group access table. Each viewer must hold a valid session-based or group-based decryption key, and key delivery is managed through the system's conditional access infrastructure.

The device-channel streaming map may be updated dynamically and may interface with other system modules such as: the group address channel manager (to monitor viewer counts per channel), the peer access control module (to verify trust and access rights), and the secure access system (to coordinate connection and stream replication).

This architecture ensures that each active channel has a resilient distribution path and enables scalable, uninterrupted group access, even in the presence of dynamic user behavior or system churn.

### Multicast Streaming, Group Replication, and Encrypted Segment Caching

In certain embodiments, the system enables a user-owned device hosted within the datacenter to stream a broadcast television channel as an encrypted video stream to a designated network switch. The stream is transmitted using multicast protocol standards and is directed to a designated multicast port on the switch.

The network switch is configured to function as a replication point, duplicating the encrypted stream for distribution to multiple other verified devices or applications associated with members of the datacenter group who are authorized to receive the content. Distribution decisions are based on group addressing logic, which is maintained by a channel manager or access control subsystem. Each recipient must have an active session and hold a valid decryption key, which is issued via the system's conditional access infrastructure.

In some implementations, the network switch includes or is connected to a local cache storage buffer used to store encrypted segments of the multicast stream in real time. This enables features such as pause, resume, and time-shifted playback, while preserving end-to-end encryption and content security.

The cached segments remain encrypted throughout storage, and may be indexed by timestamps, segment identifiers, or encryption block sequences. Access to cached content is permitted only for authenticated group members who are authorized to receive the live stream, and who possess valid session-based or group-based decryption keys. Each request to access cached content may be evaluated against session credentials, geographic restrictions, and playback policies.

The system may enforce time-based expiration of cached segments, maximum buffer length, or replay windows in compliance with licensing policies or user account tier. Segment-level access may be audited, and cached data may be watermarked or encrypted with rolling keys to prevent misuse.

This architecture allows for bandwidth-efficient group distribution, low-latency replication, and edge-level interactivity, all while maintaining compliance with privacy, licensing, and geographic access controls.

### Ad Manager System and Local Ad Insertion Architecture

In certain embodiments, the system includes an ad manager system designed to enable dynamic, targeted, and localized advertisement insertion into television broadcast content delivered to user-owned devices hosted in or connected through the datacenter. The ad manager system operates in conjunction with content delivery, playback, and user session management components and may function in both live streaming and time-shifted playback contexts.

The ad manager system is configured to receive advertisement marker data from one or more of the following sources:

In-band stream signaling, such as SCTE-35 or SCTE-104 cue messages embedded within the ATSC transport stream, Out-of-band metadata channels, such as sidecar XML/JSON over HTTPS, delivered in synchronization with the primary video content, Pre-ingested ad break maps, retrieved from an external schedule (e.g., VAST/VMAP-compliant ad manifest) associated with the programming.

Upon detection of an ad marker indicating the beginning and end of an ad break, the ad manager evaluates a set of targeting criteria that may include: the viewer's geographic region (e.g., DMA or ZIP code), demographic or behavioral profile (if permitted by privacy policy), device type or application ID, available ad inventory, frequency capping or exclusion rules.

The ad manager system selects one or more replacement ads to be delivered to the user for local playback. These ads may be retrieved from a remote ad decision server, cached in advance on the device or application, or retrieved in real time based on bandwidth availability and response latency.

The selected ad insertion data—which may include video files, image banners, interactive overlays, or tracking beacons—is transmitted to the user-owned set-top box or playback application, which is responsible for performing local insertion into the video playback timeline. Local insertion may be achieved by: dynamically splicing the replacement ad content into the player buffer, replacing transport stream packets at the decoder layer, switching playback streams during the ad window using client-side logic, or overlaying visual ad elements during identified ad breaks.

The playback device may also: monitor ad completion, report impression metrics back to the datacenter ad server (e.g., quartile tracking, completion, skip events), enforce DRM or playback protection requirements, and confirm that inserted ads meet timing constraints specified by the original ad markers.

Importantly, this system supports client-side ad enforcement, ensuring that ad targeting and delivery are performed in compliance with regional advertising rules (e.g., GDPR, CCPA) and contractual insertion restrictions. The datacenter does not modify the core program stream and is not required to decode or insert ads into the stream itself, maintaining a neutral transport role while enabling localized personalization on the edge.

In some implementations, the ad manager system may coordinate with: the conditional access system, to ensure only authorized users receive sponsored content, the group address channel manager module, to synchronize ad breaks across users receiving the same content stream, and the video storage manager, to tag or insert ads during time-shifted playback or DVR review sessions.

Local insertion enhances bandwidth efficiency, allows for targeted ad revenue models, and respects user privacy by distributing ad logic to the client device rather than requiring central stream rewriting. Ad tracking and telemetry are performed with user consent, and identifiers used for targeting are transient or session-based to preserve user anonymity where required.

Broadcaster Ad Replacement with Revenue-Optimized Dynamic Insertion

In certain embodiments, the ad manager system is further configured to analyze advertisement marker data embedded within or delivered alongside the video stream in order to distinguish between broadcaster-inserted advertisements and local ad avails reserved for regional insertion. This distinction allows the system to implement selective ad replacement strategies, targeting specific ad segments for dynamic substitution without disrupting editorial or programming content.

Broadcaster-inserted advertisements typically originate from the national or network feed and may be embedded directly within the ATSC stream, either as MPEG-TS segments or as encapsulated sub-streams marked by SCTE-35 cue messages, SCTE-104 signals, or equivalent in-band timing markers. These markers may include unique segmentation descriptors, such as segmentation_type_id, segmentation_upid_type, or segmentation_event_id, which identify the origin and type of the ad content.

The ad manager system is configured to monitor and parse these markers in real time, extracting both temporal boundaries (e.g., start and end times of ad breaks) and contextual metadata that indicates whether the segment is:

A network-controlled ad block, or A local avail, designated for insertion by affiliates or distribution partners.

Upon identifying a broadcaster-inserted advertisement segment, the ad manager evaluates whether to perform dynamic ad substitution, subject to system policy, contractual rights, and regulatory compliance.

If replacement is permitted, the ad manager consults one or more of the following components to select an alternative ad asset: An ad scheduling engine, which ensures compliance with contractual delivery obligations, slot rotations, and frequency caps; A revenue optimization module, which ranks eligible ads based on historical performance (e.g., click-through rates, completion rates), estimated CPM (cost per mille), geographic relevance, and user engagement likelihood; A targeting and eligibility filter, which limits ad eligibility based on viewer region, session context, and content classification rules.

The replacement ad is then transmitted to the user's device or playback application, where it is locally inserted in place of the broadcaster feed. This may involve: Muting or masking the original stream during the broadcaster ad segment, Overwriting the video buffer with the replacement ad, Or switching to an alternate ad playback pipeline while maintaining stream continuity and timing alignment.

The system ensures that the inserted ad content maintains the same duration and playback cadence as the replaced segment to avoid disrupting downstream stream synchronization. Optional mechanisms such as ad beacons, impression tracking, and viewability telemetry may be included to log performance data and update ad serving algorithms over time.

In cases where no suitable replacement is available, the system may default to allowing the original broadcaster ad to play through. This fallback logic ensures continuous content availability and preserves user experience.

This broadcaster ad replacement architecture enables a hybrid ad model where national feed content is dynamically augmented or overridden by datacenter-personalized ad delivery, improving monetization efficiency while preserving viewer access rights, compliance boundaries, and regulatory standards for fair use and retransmission.

### Flexible Triggering and Processing of Replaceable Ad Slots

In some embodiments, the system supports a flexible and extensible framework for triggering ad slot replacement based on replaceable ad slot indicators, which may originate at any point within the ad delivery chain. These indicators serve as actionable metadata flags that define specific ad segments as eligible for dynamic substitution, replacement, or augmentation. They can be embedded, transmitted, or generated in-band or out-of-band, and processed in real time or during pre-processing phases.

A replaceable ad slot indicator may include, but is not limited to: SCTE-35 cue messages with custom segmentation_type_id values, Pre-roll/post-roll metadata packages in OTT video manifests (e.g., HLS/DAI), VMAP (Video Multiple Ad Playlist) or VAST (Video Ad Serving Template) markup signals identifying dynamic ad opportunities, API-based triggers inserted by an ad decisioning system, server-side ad insertion (SSAI) controller, or demand-side platform (DSP), Proprietary event triggers embedded by a broadcaster, network affiliate, or syndicator, User-generated signals, such as fast-forward/skipping behavior or user preference data.

The system is configured to detect these indicators at various integration points, and to respond by initiating a replacement ad selection and insertion workflow. Depending on system configuration, network architecture, and policy enforcement, the ad processing and replacement execution may occur at one or more of the following locations:

Datacenter—The central ad server or content distribution system receives the indicator and

performs prefetching, session routing, and encryption of the selected replacement ad, forwarding it to the user endpoint as a pre-aligned content fragment.

User-Owned Device—The device detects the indicator (e.g., SCTE-35 cue in ATSC stream) and locally selects or receives a replacement ad from a previously cached ad inventory, inserting it directly into the playback timeline.

Set-Top Box (STB)—The STB acts as an edge insertion point, handling real-time playback logic, UI overlays, and impression tracking based on commands tied to the indicator.

Mobile Application or Smart TV App—The application parses metadata from adaptive bitrate (ABR) manifests or in-band signaling and manages ad selection logic in-app, leveraging device-level context such as location or user behavior.

Cloud Platform—In cloud-centric implementations, the indicator is processed by a distributed service layer that orchestrates ad delivery using microservices, CDNs, or edge compute nodes. This allows for scale-out processing and targeted delivery without modifying the core content stream.

In all cases, the system ensures that replacement ads match the duration and boundary constraints of the original ad slot, and that all ad targeting, compliance, and encryption policies are maintained. The ad insertion process may also support adaptive resolution selection, DRM wrapping, companion banner synchronization, and analytics beaconing tied to the triggered slot.

The system's ability to accept triggers from multiple points in the delivery chain—and to

perform ad processing across various execution environments—enables highly customizable, scalable, and policy-compliant dynamic ad insertion workflows suitable for hybrid broadcast-OTT systems.

### Encrypted Ad Marker Insertion and Conditional Replacement

In certain embodiments, the system supports the insertion of encrypted ad marker data into a video stream by a broadcaster, affiliate, or authorized content distributor. These encrypted ad markers are used to flag specific ad slots in the stream as conditionally replaceable, but only under predefined authorization rules. This mechanism provides upstream content originators (e.g., networks or affiliates) with a way to maintain control over ad replacement while enabling dynamic personalization or monetization in downstream playback systems.

The encrypted ad marker data may be embedded in the transport stream using standards-compliant in-band signaling protocols, such as: SCTE-35 messages with proprietary descriptors or encrypted segmentation descriptors, Encrypted cue points inserted into HLS, DASH, or CMAF manifests using EXT-X-DATERANGE or event stream metadata, Custom signaling metadata encapsulated in out-of-band JSON or XML manifest files tied to playback timelines.

Each encrypted marker may encode: A unique ad slot identifier, such as a content segment ID or event tag; A slot type designation (e.g., broadcaster-owned, affiliate override, sponsor block);

A conditional replacement flag, which may indicate that replacement is allowed only under authorized conditions; A digital signature or key-wrapped token, ensuring that only trusted playback systems or ad managers with the proper decryption credentials can interpret or act on the marker.

These markers are inserted at the headend, network operations center (NOC), affiliate transmission site, or regional playout center, and propagate downstream through the delivery chain in their encrypted form. The markers are not interpreted or acted upon until the video stream reaches a compliant device or application configured to evaluate preauthorization criteria.

Preauthorization criteria may include: Geographic eligibility, ensuring that replacement is allowed only in designated markets; Viewer account type or subscription tier; Ad inventory availability, where replacement is permitted only when a qualified substitute ad exists; Regulatory flags, such as age-restricted content, political ad compliance, or emergency override exclusions.

When the playback system (e.g., set-top box, mobile app, or smart TV) encounters an encrypted ad marker, it may attempt to decrypt and verify the marker's integrity using pre-issued keys or session-based tokens. If verification succeeds and all conditions for replacement are met, the system will request and insert an authorized replacement ad in place of the original broadcaster ad. If any verification step fails or if the policy does not authorize replacement, the original ad segment plays unaltered.

This model preserves the broadcaster's right to designate protected or non-replaceable content, supports revenue-sharing scenarios with downstream operators, and ensures that ad integrity and contractual limits are enforced programmatically through encrypted metadata and authorization logic.

Encrypted Ad Markers with Scheduling Correlation and Synchronized Substitution

In certain embodiments, the system supports the detection and processing of encrypted ad markers embedded directly within a broadcast or IP-delivered video stream. These ad markers are generated by the broadcaster or content originator and are used to identify the boundaries and context of broadcaster-inserted advertisement segments. To protect against unauthorized manipulation or substitution, the marker payloads are encrypted prior to transmission.

The encryption of ad marker data may be performed using: AES-128 or AES-256 symmetric encryption, optionally with initialization vectors (IVs) bound to session or time-based parameters; Public-key infrastructure (PKI) with broadcaster-signed tokens for integrity assurance; Key exchange protocols tied to a conditional access system (CAS), or to an external ad rights management platform.

The ad manager system is configured to detect and extract these encrypted markers from the video stream. Marker detection may occur via: In-band SCTE-35 signaling embedded within MPEG-TS or ATSC transport streams; Timed metadata embedded within adaptive streaming manifests (e.g., HLS, DASH with EventStream or EXT-X-DATERANGE); Out-of-band stream control metadata delivered via sidecar files or broadcaster APIs.

Upon detecting an encrypted marker, the ad manager: Decrypts the marker using a secure key, which may be: Provisioned by the broadcaster in advance; Retrieved dynamically from a key server; Issued per-session or per-broadcast using secure key exchange protocols; Parses the decrypted marker to extract data such as: start_timecode, duration, event_id, or segmentation_upid; A unique advertisement slot ID or marker label; Substitution conditions or fallback instructions. Correlates the marker with broadcaster-supplied scheduling data, such as: Linear ad traffic logs (e.g., in BXF, Excel, or XML format); Live playlist metadata or affiliate avails; Programmatic ad schedules integrated from ad servers or SSPs. Once the ad marker is successfully decrypted and correlated, the ad manager selects a replacement ad based on system policy, ad eligibility, or real-time bidding logic. It then performs synchronized ad substitution by aligning the start of the replacement ad with the precise timing boundaries specified in the decrypted marker (e.g., frame-accurate substitution or timecode-aligned insertion).

The synchronization logic may include: Preloading or buffering the ad content to minimize latency; Validating playback readiness prior to the substitution point; Logging or beaconing the substitution event for billing or compliance.

This architecture ensures that broadcaster-inserted ads can be securely and selectively replaced under controlled conditions, preserving timing integrity, respecting contractual ad slots, and supporting dynamic monetization without compromising content rights or introducing playback artifacts.

### Standards-Based Ad Retrieval and Format Matching for Ad Replacement

In certain embodiments, the system is configured to retrieve replacement advertisements from one or more ad sources using standard, widely adopted advertising protocols. These protocols include: VAST (Video Ad Serving Template): a specification for serving linear video ads via XML metadata, widely supported in programmatic video advertising ecosystems; VPAID (Video Player-Ad Interface Definition): which enables interactive or dynamic creatives, typically delivered through JavaScript or Flash wrappers; VMAP (Video Multiple Ad Playlist): used to define a timeline of multiple ad breaks within long-form content; MRAID (Mobile Rich Media Ad Interface Definitions): used for interactive ads within in-app environments, particularly on mobile platforms.

Upon receiving a replaceable ad marker or ad break trigger, the system initiates a standards-compliant ad request to a configured ad server, ad exchange, demand-side platform (DSP), or local ad cache. The request may include targeting parameters such as: Geographic location, User session data or behavioral context, Playback device type, Slot duration and placement metadata, Creative type preferences or restrictions.

The returned ad payload may include one or more media assets or ad instructions, formatted in one of several supported types, including but not limited to: Linear video advertisements (pre-roll, mid-roll, post-roll), delivered as MP4 or HLS/DASH media files; Banner ads, including in-player overlays or static image displays (e.g., PNG, JPG, HTML5); Interstitial ads, which pause underlying content and present a full-screen creative; L-shaped or corner-wrap ads, which wrap the video player frame with branded content while allowing the original stream to continue.

In configurations where timing or stream integrity must be preserved, the system may enforce duration-matching constraints, ensuring that the replacement ad matches the length of the original ad slot. This allows for seamless reintegration of content playback without disrupting manifest timing, audio/video synchronization, or group-viewer alignment.

Replacement ads may also include interactive elements, companion banners, or tracking beacons for impression logging, click-through measurement, or real-time analytics. Playback systems interpret the ad markup and render the creative according to protocol-specific execution rules.

In mobile, CTV (connected TV), and hybrid web environments, the system ensures compatibility by detecting playback environment capabilities and dynamically selecting the ad format and protocol best suited for that environment (e.g., MRAID for mobile in-app, VAST for CTV linear streams).

The system may also cache standard protocol responses for repeat use, apply frequency capping, or maintain creative rotation logic to meet advertiser campaign constraints and enhance viewer experience.

In certain embodiments, the system supports a trial mode designed to onboard prospective users through a limited-duration access window to a datacenter-hosted device. This mode allows users to experience the system's features, including access to over-the-air broadcast content, personalized playback interfaces, and conditional access infrastructure, prior to committing to full registration or purchase.

During the trial period, the system assigns a dedicated device to the trial user under one of the following models: Temporary ownership, wherein the device is provisionally sold or assigned to the user with an option for full ownership conversion upon successful verification; Conditional sale or loan-to-own, where the user assumes temporary control and receives permanent ownership if eligibility conditions are met; Exclusive individualized assignment, where the datacenter ensures that the device is not shared or reassigned to any other user during the trial period, thereby maintaining the one-to-one control model required for regulatory compliance.

Throughout the trial period, the assigned device is under the exclusive control of the prospective user, and system-level access controls, session pairing, or encryption keys ensure that only the trial account holder may access, tune, or decrypt content on that device. Shared, pooled, or virtualized access to the device is explicitly prohibited, even during the trial.

To qualify for trial access, the system requires initial geographic presence validation, which may include: IP address geolocation, GPS-based location services (in the case of mobile sign-ups), A broadband provider geofence check, or Wi-Fi SSID verification if available from the user's device.

After the user begins using the system in trial mode, they must complete a secondary verification step to determine long-term eligibility. This step includes submission and validation of a residential address, which is compared against one or more geographic eligibility rules defined by: FCC broadcast regions, broadcaster licensing agreements, local content distribution rights, or datacenter-defined service zones.

Residential address verification may be completed using: A mailed registration code (e.g., USPS verification letter), A utility bill or other proof of residence document upload, A third-party identity and address verification API, Or an in-person kiosk with ID scanning, in jurisdictions where required.

If the user fails to complete address verification or is determined to be outside of the service region, their trial session is terminated and access to the assigned device is revoked. If verification is successful, the system transitions the user from trial mode to full service status, optionally converting the trial device into a permanent assignment or triggering device shipment for home-based control models.

In certain embodiments, the system supports a trial mode, enabling prospective users to temporarily access a dedicated device hosted in the datacenter for evaluation purposes. This trial mode is intended to provide a full-featured preview of the system's capabilities, including access to live or time-shifted broadcast television, personalized playback features, and remote device control functionality.

During the trial period, each user is assigned a dedicated device under one of the following exclusive-control models: Temporary ownership, wherein legal ownership is conditionally granted for the duration of the trial and converted to permanent ownership upon successful verification; Conditional sale, wherein the device is sold to the user pending the outcome of eligibility checks; Individualized assignment, wherein a specific device is reserved and locked to a single user account, with system-level protections that prevent access by any other user during the trial period.

In all configurations, the assigned device is operated under the principle of exclusive user control—no device pooling, sharing, or virtualization occurs, and all tuning, playback, and session management is uniquely linked to the trial user's authenticated session. This design ensures that the trial experience mirrors the privacy and legal characteristics of full device ownership.

To qualify for access under trial mode, the system first performs an initial eligibility check based on the user's geographic presence. This may include: IP-based geolocation at signup, GPS or device-based location services, when available, ISP-based region detection, Wireless network geofencing for mobile platforms.

If the user's real-time geographic presence is within an authorized service region, access to the trial device is granted for a predefined duration (e.g., 48 hours, 7 days). During this period, usage is monitored for compliance with system policies, and the user is prompted to complete a secondary eligibility verification process.

The secondary verification involves submission and validation of the user's residential address, which must fall within the designated geographic broadcast rights zone applicable to the datacenter's licensing agreements or regulatory boundaries. Address verification may be conducted using one or more of the following mechanisms: Mailed confirmation letters containing unique registration codes (e.g., USPS address validation), Utility bill or government-issued ID upload, verified through third-party services, Online third-party address matching APIs (e.g., Experian, LexisNexis), Trusted digital identity systems with built-in address validation.

If the user successfully completes address verification and is deemed eligible, the system transitions the account to full member status. This may trigger: Permanent assignment or confirmation of ownership of the device used during trial, Device reassignment or upgrade, based on membership tier, Activation of ongoing remote access privileges.

If the user fails to verify their address within the required time window, or if the address falls outside authorized service areas, the trial session is terminated and the device is either reclaimed, reassigned to another eligible user, or remotely disabled until reactivation criteria are met.

This trial architecture enables scalable user acquisition, maintains legal compliance with geographic and licensing restrictions, and ensures that device exclusivity and user entitlement validation are enforced even during limited-access evaluation periods.

### User-Owned Device Hosting Under Co-Location Agreement Without Aggregation or Retransmission

In certain embodiments, the system operates under a co-location or hosting model, wherein a user-owned reception device is physically installed within a datacenter environment operated by a service provider. The hosting arrangement may be structured as a: rack rental agreement, dedicated hosting contract, or co-location agreement, wherein the datacenter provides the user with access to infrastructure resources, but retains no ownership or operational control over the device itself or the content it receives.

Under this model, the device is owned, registered, and controlled solely by the user, and is paired to the user's verified identity and residential address through the system's onboarding and access control procedures. The datacenter provides the following services to support device operation: Physical rack space sufficient to mount or house the reception device; Uninterrupted electrical power, potentially backed by UPS and generator redundancy; Network connectivity, including switching infrastructure, NAT traversal, and external IP assignment to allow authenticated remote access by the device owner.

Importantly, the datacenter operator: does not access, aggregate, transcode, repackage, or retransmit any content received or transmitted by the user-owned device; does not combine content from multiple user devices for simultaneous distribution; does not originate or manage program schedules, playback queues, or central feeds; and does not decrypt or alter broadcast signals at any point.

All content routing, tuning decisions, and playback access are exclusively initiated by and delivered to the individual user, using the control interface (e.g., mobile app, set-top box, or software client) associated with their verified account. This structure ensures that the system operates strictly as a private extension of the user's personal antenna and tuner, relocated to a secure, managed facility for better reception and system performance.

The datacenter's role is explicitly limited to that of an infrastructure provider-analogous to a landlord leasing power and connectivity-and not that of a content provider, distributor, or multichannel video programming distributor (MVPD). This model is compliant with copyright and telecommunications frameworks that distinguish between passive co-location services and active content retransmission.

### Datacenter Device Inventory, Assignment, and Exclusive User Access

In certain embodiments, the datacenter maintains a pre-provisioned inventory of ATSC reception devices intended for assignment to individual users through purchase, lease, or trial enrollment. These devices are physically installed within the datacenter's secure equipment racks and remain inactive or unassigned until a user initiates a registration, purchase, or trial session.

The inventory may consist of: Standalone ATSC tuner/decoder units, Embedded ATSC capture devices within rack-mounted compute nodes, Integrated set-top box systems configured for remote access, or Virtualized device instances with hardware-level tuning capabilities allocated on a per-user basis.

Upon initiation of a purchase, the system registers the selected device to the purchasing user and records a permanent ownership relationship within the datacenter management system. Alternatively, if the user opts to lease a device or activate a trial, the system assigns a device from the available inventory to the user's account for the designated duration and contract terms.

Assignment may include: Activation of exclusive network access to the device, Generation of session-specific or persistent encryption keys, Secure pairing of the device to the user's playback application or remote management interface, Application of conditional access controls to enforce that only the registered user may tune, stream, or control the device.

Once assigned, the device becomes part of the user's personal reception and playback environment, even though it remains physically located in the datacenter. The datacenter operator: Does not co-mingle access to that device with any other user; Does not tune or retransmit content from the device to the general public or shared endpoints, And enforces network and application-layer controls to ensure that all device communications and playback sessions are authenticated against the registered user account.

Devices within the datacenter inventory may be configured at the time of assignment based on user preferences or account tier, such as: Geographic tuning restrictions aligned with the user's validated residential address, Encrypted channel output for use in group addressing or private session sharing among authorized viewers, Recording or time-shifting features, if included in the user's access plan.

Inventory tracking may include barcode, MAC address, or hardware ID indexing, and the datacenter may support internal logistics to move, repair, or upgrade assigned devices. However, device reassignment is strictly prohibited during the active registration period unless triggered by: Device failure and authorized RMA (return merchandise authorization), User cancellation or disqualification, Account conversion from trial to full purchase or lease agreement.

This provisioning model enables scalable onboarding, enforces user-specific hardware control, and ensures compliance with regulatory frameworks requiring that each user have access to a non-pooled, private device for the receipt of geographically-restricted ATSC content.

### Regional Broadcast Preference Selection and Multi-Market Access Controls

In some geographic areas, a user may be located in a region where overlapping ATSC broadcast signals from two or more regional markets are accessible. For example, a user situated in central New Jersey may receive broadcast signals from CBS New York (WCBS-TV), CBS Philadelphia (KYW-TV), and CBS Washington, D.C. (WUSA). These signals, while affiliated with the same national network, may carry different local programming, including: Distinct local news segments (e.g., CBS Philly's 11 PM newscast), Regionally prioritized sports broadcasts (e.g., NFL coverage preferences on CBS NYC), Market-specific syndicated or talk show programming (e.g., CBS DC daytime lineup).

To enhance personalization and avoid content duplication or confusion, the system provides a regional broadcast preference setting within the user application interface. This interface allows users to: View a list of available network affiliate stations for each major broadcaster (e.g., CBS, NBC, FOX, ABC), Select a preferred affiliate per network, which is stored as a user-level profile setting, Optionally tag use-case-based preferences (e.g., “CBS NYC for sports,” “CBS Philly for local news,” “CBS DC for talk shows”) within the app.

These preferences influence: The default channel presented when launching live TV playback for that network, DVR or time-shifted content selection logic, Group access or shared-viewing stream alignment when a preferred station is available to multiple verified members.

The system ensures that each preferred station is: Legally available to the user based on verified geographic eligibility, Tuned through the user's assigned reception device, which is physically located within the signal footprint of the selected station, Accessed only by the individual user or authorized group members, maintaining compliance with content access rules and copyright law.

The regional preference interface may include: Dropdown selectors or swipeable menus by network, Preview thumbnails or metadata for each affiliate (e.g., market, call sign, schedule), Real-time availability indicators based on device tuning capabilities, User notes or tags for context-specific preferences (e.g., “use CBS DC when news overlaps”).

This feature improves the viewing experience in multi-market zones, gives users explicit control over which station they access from overlapping networks, and helps maintain system compliance by enabling user-specific access decisions rather than operator-level content aggregation or prioritization.

The determination of which broadcast affiliate stations are eligible for selection by a user is based, in part, on FCC-defined broadcast signal contours, including Grade A and Grade B signal areas, as published in FCC licensing and market mapping databases. The system may access FCC signal coverage maps, such as those available through the FCC TV Query or FCC GIS contour services, to determine whether a user's verified residential address or their reception device's installed location falls within the signal reach of a particular station. These maps provide an authoritative basis for defining multi-affiliate availability zones, allowing the system to offer lawful access to multiple network affiliates only when technically and legally justified. The system may also incorporate predictive models or third-party reception data (e.g., Signal GH, RabbitEars.info, or antennaweb.org datasets) to validate and supplement FCC-derived eligibility boundaries.

### Customizable Topic-Based Parental Controls and Content Filtering

In addition to traditional parental control mechanisms based on age-based content ratings (e.g., MPAA, TV Parental Guidelines), the system supports a customizable, topic-based filtering architecture that allows users to define and enforce personalized content restrictions based on specific themes, language, or subject matter.

The system ingests and processes content-related metadata from one or more of the following sources: Electronic program guide (EPG) data, including extended episode descriptions; SCTE-104 or SCTE-35 in-stream cue messages, with enhanced content classification tags; Out-of-band metadata supplied by broadcasters or third-party tagging services; AI-generated or publisher-provided content labels, derived from speech-to-text analysis, subtitle analysis, or pre-encoded metadata; Closed-captioning tracks, which may be processed for language detection or sensitive topic identification.

These metadata inputs may be used to classify content into fine-grained filtering categories, including but not limited to: Language-based filters (e.g., profanity, slurs, suggestive speech); Sexual content flags (e.g., innuendo, nudity, adult themes); Violence or self-harm references; Social and identity topics, such as references to: Gender identity and expression, Transgender or non-binary individuals, Sexual orientation, Political movements, Religious or cultural criticism.

Parents or account holders may configure their profiles to include or exclude content tagged with any of the above categories. The system offers multiple enforcement modes, such as: Block mode, which suspends playback when flagged content appears; Mask mode, which obscures video or mutes audio temporarily; Preview mode, which alerts the user or guardian before playback proceeds; Log-only mode, which records access to flagged content for review without blocking.

Filtering is performed locally at the user's playback application and does not require central reprocessing or modification of the broadcast stream. This ensures that: Content is not censored or modified in violation of copyright or carriage terms; Group addressing and stream efficiency are preserved; Each user or household retains full control over the presentation of sensitive content.

Enforcement may leverage keyword matching within transcript data, topic IDs embedded by content producers, or third-party classification services that return content sensitivity flags on a per-program, per-segment, or per-episode basis. Optional support for user-submitted tags or community consensus filters may also be included in customizable environments.

Machine Learning-Based Content Classification and Personalized Blocking Recommendations

In certain embodiments, the system applies machine learning (ML) algorithms to enhance the accuracy, adaptability, and personalization of its content filtering and parental control mechanisms. These ML models are designed to classify video content, predict viewer preferences, and recommend or automate content blocking actions based on a combination of user-defined policies, historical viewing behavior, and detected content attributes.

The machine learning architecture may operate on a variety of data inputs, including: Program metadata, such as title, episode description, genre, and broadcast source; Transcript data, extracted from closed captions, subtitle files, or speech-to-text analysis; Audio and video feature extraction, identifying tone, scene types, music, or on-screen visuals indicative of mature or sensitive content; Third-party content classification scores, such as parental advisory databases, content sensitivity APIs, or industry-standard ratings; User behavior logs, including prior playback blocks, skips, watch durations, and user-submitted content ratings.

Using these features, the system trains or deploys one or more supervised or unsupervised ML models, such as: Content classification models (e.g., logistic regression, CNNs, BERT-based NLP models) to identify sensitive content themes; Collaborative filtering models or reinforcement learning agents to optimize recommendations; Anomaly detection models to flag content that deviates from a user's established preferences.

Based on model output, the system may: Automatically recommend blocking of new or upcoming programs that match a user's sensitive content profile; Suggest additional filters or refinements to the user's parental control settings; Dynamically adapt default filters over time as user behavior indicates increased or decreased tolerance for specific themes; Flag potentially misclassified content for review by the user or a guardian before playback.

These recommendations are surfaced in the user interface with appropriate labels, confidence scores, or explanation indicators (e.g., “Blocked due to predicted suggestive dialogue—92% confidence”). The final decision to apply or override ML-generated filtering remains with the user or account administrator.

ML processing may occur: Locally within the playback application using on-device models, In a centralized cloud inference engine linked to user accounts, Or as part of a federated learning framework, where user data remains private but models improve over time across the user base.

This adaptive filtering system provides a privacy-conscious, user-directed mechanism for preventing exposure to objectionable or controversial content, even when that content is not explicitly flagged by broadcasters or rating agencies. It also enables the system to keep pace with changing media trends and individual sensitivities, delivering a safer, more personalized viewing experience.

The system may further incorporate historical program-level data into its machine learning classification and recommendation process. This includes past episodes, seasons, or airings of the same show or series, wherein previously flagged content (e.g., controversial themes, sensitive dialogue, explicit scenes) has been recorded through: System-level tagging, Community-based feedback, Manual moderation review, Or prior user blocks and skip events.

This historical content profile enables the system to predict potential objectionable content in new or upcoming episodes of the same show or series, even before full metadata or transcripts are available. For example, if a talk show frequently includes political topics or social commentary disallowed by the user's content filters, the system may preemptively recommend or enforce blocking of new episodes unless specifically overridden.

This predictive blocking may also extend to content from the same producer, network, or creative team, when historical content patterns align with the user's exclusion criteria.

### Predictive Parental Content Filtering Using Historical Program Behavior and External Social Signals

In certain advanced embodiments, the system includes a predictive parental filtering engine designed to help parents or guardians restrict access to content based on an analysis of prior program behavior, inferred content themes, and external public feedback, rather than relying solely on static age ratings or network-supplied metadata.

The filtering engine evaluates both structured content data and contextual social signals to determine whether a program—including a new or upcoming episode—is likely to conflict with a child's viewing restrictions. Key components of the analysis include:
1. Historical Content Behavior Analysis

The system maintains a program history profile for each show, series, or content producer. These profiles may include: Prior audio analysis using speech-to-text models that detect objectionable language, suggestive dialogue, profanity, or controversial terms (e.g., explicit references to gender identity, sexual behavior, political extremism, etc.); Closed caption data from past episodes, allowing for textual filtering, tone detection, and topic extraction; Scene segmentation and tagging of prior episodes using AI tools to label visual content (e.g., violence, mature themes, drug use, etc.); Viewer-level engagement data, such as prior blocks, user reports, flagged moments, or manual skip events by parents or other users with similar filtering criteria.

### Influencer and Community-Based Risk Signals

The system optionally ingests trusted commentary or reputation signals from: Religious leaders (e.g., pastor recommendations, faith-based media rating groups), Educational networks or advocacy groups focused on family media safety, Social media sentiment analysis, where public reactions to a show—including reviews, parent forum posts, and community watchdog feedback—are used to estimate whether a program aligns with a user's values or household content standards.

These external sources may be integrated using: A curated RSS or API feed of show advisories or review alerts; Sentiment-scored social media keywords that correlate to episodes or programs (e.g., spikes in mentions of “inappropriate for kids,” “sexual content,” “political indoctrination”); Custom “trusted source” filters selected by parents (e.g., “block shows flagged by SafeFaith Media”).
3. Predictive Risk Scoring and Blocking Logic

Based on historical and contextual inputs, the system generates a risk score or appropriateness rating for each program or episode. These predictions may be based on: Supervised ML models trained on historical block behavior; NLP-driven content analysis across transcripts and captions; Classification trees using source credibility, prior content, and parent-defined filtering logic.

If the predicted score exceeds the configured tolerance set by the parent or guardian, the system may: Automatically block access to the program before the child views it; Present a parental review warning, allowing the guardian to approve or deny access; Log the show in a “needs review” watchlist for future review or override.

This predictive filtering can operate in both live playback (e.g., block mid-stream based on real-time detection or known profile) and pre-playback validation (e.g., block the channel or show at the guide level if flagged).

These mechanisms provide families with a customizable, intelligent, and proactive content safety system that reflects their personal values and protects children from exposure to content deemed unsuitable based on more than just general age ratings.

Network Bridge and Encrypted Playback In another embodiment, the system includes a network bridge component that links each datacenter subscriber account to one or more user-owned devices hosted in the datacenter. This bridge enables seamless group addressing and secure video playback across verified members within the geographic restriction zone. When a user-owned device is tuned to a broadcast channel, the bridge facilitates encrypted video storage and conditional playback for other verified users, maintaining privacy and regional compliance. If the primary device owner cancels their subscription or goes offline, the system may automatically shift access to a redundant backup device tuned to the same channel, ensuring uninterrupted service to remaining members. This approach increases system reliability and reduces hardware duplication while preserving legal boundaries by maintaining individual device ownership and encrypted conditional access.

### Network Authentication and Device Access Management

In another embodiment, the invention includes a secure method for establishing communications between a client application and a user-owned device hosted in a datacenter, across a large-scale environment comprising thousands of devices. The process may occur in any logical order and begins when a subscriber opens a client application (on IOS, Android, smart TV, or browser) and initiates a request to access their user-owned device. The application first performs network authentication, either through: a login credential specific to the datacenter network (e.g., VPN token, API key), or through a device-specific login, such as a private key, device ID, or one-time authentication handshake. Once authenticated, the client application sends a request to the datacenter. This can be routed in several ways: Direct addressing (private or NAT-mapped): Each user-owned device is provisioned with a unique internal IP address or tunnel endpoint during the registration process. The datacenter network uses NAT, port forwarding, or VLAN tagging to map external requests to the correct device. Proxy routing model: All user requests are initially directed to a common proxy or gateway IP. A request router or application-layer proxy inspects session tokens and account metadata to forward requests to the appropriate user device. This method simplifies firewall and IP management for large-scale deployments.

Transparent bridge with access control: The datacenter uses programmable networking equipment (e.g., SDN switches, firewalls) that dynamically enables or blocks traffic to each user device based on account status. When an account is active, the datacenter allows passthrough traffic to the device. When an account is suspended or terminated, network traffic is blocked upstream of the device. In all modes, the user device may optionally send heartbeat messages or access-ready signals to the datacenter's control plane to indicate availability, triggering automatic enablement of network paths. Alternatively, the network can maintain persistent routing to the device with authentication validated at the application layer. To support tens of thousands of devices (e.g., 10,000 or more), the system uses scalable network management tools. These include dynamic address tables, authentication logs, session control modules, and device-indexed configuration databases. This ensures that the client application can always connect to the correct device with low latency, even in large deployments.

User Consent for Group Addressing Participation In one embodiment, the invention includes a legal compliance framework in which users must affirmatively accept specific terms and conditions prior to participating in the group addressing mode. This consent process ensures that users understand and authorize their device's encrypted output to be made available—subject to access controls—to other geographically verified members within the datacenter. Upon registration or first-time activation of group addressing, the system presents each user with a disclosure describing: That their device may, while tuned to a broadcast channel, encrypt and transmit content to other verified members. That all transmitted content remains encrypted and inaccessible to the datacenter operator or unauthorized parties. That decryption is limited to members with verified geographic eligibility, under a conditional access system. That their participation is voluntary and revocable, and their device will not participate in group addressing without consent. Users must digitally acknowledge these terms—through a checkbox, digital signature, or token-based acceptance mechanism—before the system enables their device to generate or receive encrypted group output. Consent records are stored in a compliance database and are linked to the user's subscriber profile for audit and enforcement purposes.

This process ensures that the group addressing mode operates within a transparent, permissioned framework that honors user rights and complies with copyright law by avoiding unconsented public performance or redistribution.

### Scalable Distribution Using a Network Element

In a further embodiment, the invention incorporates a scalable delivery mechanism for group addressing using a shared network distribution element, such as a multicast-enabled switch, content delivery node, or packet replicator. While an individual user-owned device may directly stream content to other members, this becomes impractical at scale due to bandwidth constraints. For example, a device with gigabit Ethernet capacity (˜800 Mbps usable throughput) can support approximately 100 simultaneous 8 Mbps video streams before saturating its uplink. This supports an effective 100:1 streaming efficiency ratio under ideal conditions.

To scale further, the system includes a network-level video replication module—a switch or server that receives a single encrypted video stream from the owner's device and replicates it to hundreds or thousands of eligible members inside the datacenter. This stream is encrypted using a group key, issued by the conditional access system linked to the owner's account. Because the stream remains encrypted end-to-end and is not decrypted by the datacenter operator, this design maintains legal separation and avoids unauthorized retransmission.

Each verified user device retrieves the group decryption key—derived or requested from the original owner's device or a secure key authority—and applies it to decrypt the stream locally. The datacenter's role is limited to routing or replicating the encrypted payload without access to content, thereby preserving compliance with copyright law and retransmission consent rules. This architecture enables single-stream distribution to thousands of members using a legally compliant and infrastructure-efficient model.

### Datacenter Device Addressing and Port Management Logic

In another embodiment, the datacenter uses a structured addressing system to route application requests to the correct user-owned device. Each datacenter is assigned a unique DNS-resolvable address, such as dc.nyc1.futuretv.tv, dc.nyc2.futuretv.tv, or dc.nyc3.futuretv.tv, and user traffic is directed to the appropriate region based on registration data.

Each user-owned device within a given datacenter is assigned a dedicated network port or NAT-forwarded address. Upon registration, the datacenter assigns a unique port number or NAT mapping to the user's device. These mappings are maintained by a datacenter connection manager, which ensures that incoming connections from user applications are routed to the correct device. The system may operate under two addressing modes: Direct IP/Port Forwarding Mode: Each user app is configured to reach the datacenter via DNS (e.g., dc.nyc1.futuretv.tv) and a specific port number allocated to their device. The datacenter's firewall or router forwards incoming requests from the app to the registered device using port-forwarding or NAT translation logic. Access is automatically blocked or rerouted if the subscriber's status is suspended or terminated. Proxy Identification Mode: The app connects to a central connection manager service within the datacenter. The app includes an access token or identifier linking it to the user's device. Upon validation, the connection manager dynamically establishes a network route to the device—either by enabling a NAT path, assigning a temporary port forward, or linking via virtual IP. The network connection is automatically created or destroyed based on session state, device status, or account permissions.

This approach ensures that thousands of user-owned devices can be securely and efficiently accessed by their corresponding applications without public exposure or centralized content handling. It also allows the datacenter to tightly control which devices are reachable based on subscription status and compliance with geographic restrictions.

### Group Addressing Port Linking and Access Table Logic

In an advanced embodiment, the invention includes a group addressing port linking system designed to efficiently distribute a single encrypted channel feed to multiple verified owner devices. When one user-owned device is tuned to a broadcast channel and initiates a group addressing mode, the system assigns a designated multicast or replicated stream to a shared logical port or multicast channel endpoint within the datacenter's internal network.

Access to this shared encrypted feed is governed by a group access table, which contains verified subscriber records for all members currently authorized to receive the stream. This table is populated after each member's geographic eligibility and account status have been authenticated by the system's conditional access manager. Each recipient device cross-checks its inclusion in the table before requesting or accepting the group feed, and uses a group key (issued per session or per channel) to decrypt the video locally.

The group access table is dynamically updated to add or remove members based on login status, subscription changes, or address compliance. This design allows for scalable one-to-many content distribution across hundreds or thousands of devices while preserving strict per-user access enforcement, ensuring legal compliance and efficient network utilization.

### Ownership Model Flexibility:

In one embodiment, the invention supports both user-owned and subscriber-assigned devices. Each device is uniquely bound to a single user account and may be owned, leased, or provisioned by the service provider for exclusive use by the verified subscriber. This ensures that content access remains personalized and does not constitute centralized retransmission, regardless of physical device ownership status.

### Flexible Geographic Verification:

The system supports multiple forms of geographic eligibility enforcement, including but not limited to: Mailing of verification codes, GPS or mobile geolocation data, IP address geofencing, Billing address validation, Or wireless triangulation. The datacenter activates or maintains access only while such verification is valid and logged.

### Routing Without Decryption Protection:

In another embodiment, even if video content is routed or replicated by datacenter infrastructure, the datacenter does not decrypt or decode the stream. The system ensures that content remains encrypted end-to-end and cannot be accessed by intermediate infrastructure, preserving legal protections under copyright and retransmission rules.

### Peer Distribution Safeguard:

To prevent circumvention via peer-to-peer relay methods, the system prohibits recipient devices from re-sharing the decrypted content and applies cryptographic session isolation, ensuring each recipient device must independently qualify for content access via key request or token authorization from the conditional access system.

### Hardware-Based Decryption Compatibility:

In a further embodiment, decryption keys may be handled by trusted hardware environments (e.g., Trusted Execution Environments or DRM cores) on recipient devices. Regardless of implementation, the content is only viewable by subscribers whose eligibility is continuously enforced.

### Specification: Persistent Device Channel Mapping and Redundant Streaming

In one embodiment, the system includes a device-channel streaming map used by all participants in a datacenter to coordinate which user-owned device is actively streaming each ATSC channel in group addressing mode. This allows efficient distribution of live broadcast streams to multiple eligible users without requiring every user to tune their own device independently.

When an owner (e.g., Owner 1) logs in and selects a channel—such as FOX Channel 5—their device begins receiving and encrypting the channel feed for group distribution. If that same owner subsequently switches to a different channel (e.g., NBC Channel 4), the system retains the original device (Owner 1's device) as the active stream source for Channel 5, unless no longer authorized or online. The new channel (Channel 4) may be sourced from a different device already tuned to that channel, or a new one may be designated based on group demand.

This functionality is made possible through a user agreement accepted during registration, which includes terms permitting a user's device to continue streaming a previously tuned channel for shared access by other eligible members, even after the original user changes channels or goes idle.

The device-channel streaming map is a dynamic registry indicating: Which devices are actively streaming which ATSC channels, Backup devices assigned per channel for redundancy in the event of failure or account cancellation, idle devices available for assignment. For example, Device 80 may be the current source for Channel 5, while Device 117 is designated as backup. Other idle devices remain registered but are not consuming resources until needed. This shared map ensures continuity of service even if a primary device is disconnected, suspended, or cancelled, and is used by the datacenter network controller to reroute encrypted group streams in real-time.

Encrypted Playback In another embodiment, the system includes a group addressing network switch that enables a single encrypted stream generated by a user-owned device to be distributed to hundreds or thousands of authenticated datacenter members. When an owner device is tuned to a channel (e.g., Channel 5), it outputs an encrypted stream to the datacenter's internal switch or router on a dedicated logical port—for example, port 60005.

The group addressing switch software maintains a mapping between active streams and port assignments. In this scenario, the switch is configured to replicate and distribute the stream received on port 60005 to up to 1,000 other authenticated owner devices, each of which has: Verified group membership; Active geographic eligibility; A decryption key issued by the conditional access system. This switch-level multicast replication ensures highly efficient delivery, reducing bandwidth, power, and device load. Because the stream remains encrypted, and the datacenter operator does not hold the decryption keys, this architecture avoids retransmission licensing issues while scaling one-to-many delivery. Pause/Resume and Catch-Up TV Mode In a further embodiment, the group addressing switch supports pause/resume functionality or catch-up playback by caching the encrypted stream temporarily in a secure buffer or rolling file-based storage. The switch may store up to several minutes or hours of encrypted video per group feed. This content remains encrypted at all times and is only playable by authenticated users who request the content using valid group keys. The group addressing switch does not decode the content, and cached video is only decryptable by group members at playback time. This approach effectively enables DVR-style time-shifting without exposing cleartext content to the datacenter infrastructure, preserving compliance with copyright restrictions and private-use exemptions. In the group addressing configuration, the encryption and decryption of video streams are managed through a group key mechanism. The group encryption key may be generated and distributed from either (a) the owner device generating the video stream, or (b) an external key management system operated independently within the datacenter infrastructure. In both models, only users who have been verified as eligible members of the datacenter—through address validation and account authentication—can receive the group key required for decrypting the content. This ensures that even when a single stream is shared across multiple users, the datacenter operator cannot access or decrypt the content, preserving legal compliance and content security. The use of external key managers further enables scalable key rotation, access revocation, and logging for audit and compliance purposes.
a. Streaming Load Optimization and Direct Device Fallback:

In one embodiment, an owner device connected via Gigabit Ethernet (˜1 Gbps) may be used as a direct fallback streaming node for group addressing. Given typical ATSC stream bitrates of ˜8 Mbps, a single device with 800 Mbps of usable throughput can serve approximately 100 verified datacenter members directly. This enables fallback operation of group addressing even in the absence of a dedicated network replication switch, preserving approximately 100:1 delivery efficiency in bandwidth and hardware usage.

In the primary mode, however, the encrypted stream is routed through a network switch or software-based multicast replicator that distributes the single stream to thousands of group-authorized users. Since the video remains encrypted and is decrypted only by end devices possessing a valid group key, the datacenter operator remains unable to access or retransmit unencrypted content.
a. Specification: Group Key Request Validation and Delivery Control
b. In one embodiment, the system includes a datacenter member management and authorization layer that ensures only authenticated applications—linked to verified users—can request group decryption keys for shared ATSC content. When a client application attempts to join a group-addressed stream (e.g., a shared encrypted feed of Channel 5), the datacenter first validates: That the app session is properly authenticated; That it is associated with a verified subscriber account; That the subscriber's physical address and eligibility have been previously authenticated per geographic licensing requirements. Only after this multi-factor verification does the system permit the client to initiate a group key request. Group key delivery may follow one of two models:

### Preferred Model—Owner-Device-Served Key:

The owner device that originated the encrypted stream (e.g., Device 80 streaming Channel 5) generates or forwards the group decryption key directly to authorized recipients. This ensures that the datacenter operator cannot access copyrighted content, as the key exchange occurs entirely between authenticated group members and the owner device.

### Alternate Model—DC Network Switch-Served Key:

In some implementations, the datacenter's internal switch or conditional access module may manage group key distribution after validating user eligibility. In this case, the switch handles secure key transport but does not retain or have access to the unencrypted video stream. Even in this model, the switch may obtain the key from the originating device or a secure envelope signed by it.
a. In all configurations, decryption keys are only issued to devices that have passed the full authentication and compliance check, and group keys are session-and channel-specific to prevent unauthorized reuse.

### Per-User Content Restriction in Group Addressing Sessions

In group addressing configurations where a single user-owned device or datacenter-hosted reception unit streams an encrypted television channel feed to multiple validated users, the system supports per-user content filtering and parental control enforcement based on individualized account settings. Each user's playback application maintains a local profile containing parental control thresholds, such as MPAA ratings, TV Parental Guidelines (TV-Y, TV-G, TV-PG, TV-14, TV-MA), or custom content labels (e.g., for language, violence, or adult themes). During group viewing sessions, where all recipients are tuned to a common channel feed (e.g., Channel 8), the system does not interrupt or alter the source stream, even if the content being broadcast temporarily exceeds the parental control threshold for one or more viewers. Instead, the affected viewer's application performs local enforcement as follows: Upon receiving program guide data or metadata (e.g., from EPG, SCTE-104, or in-band descriptive markers) indicating that upcoming content exceeds the account's rating threshold, the app initiates a block action, replacing the video feed with a content warning screen, custom placeholder, or alternative age-appropriate overlay. The audio and video playback are suspended or obscured, but the channel session continues in the background so that playback may automatically resume if the content rating falls back within acceptable limits (e.g., after a commercial break or program change). Playback resumes only after re-evaluating content rating markers to confirm that the stream is once again compliant with the user's preferences. This model enables the system to preserve: Stream efficiency, by maintaining a single group feed, Legal compliance, by not altering or reprocessing broadcast content centrally, User safety and customization, by ensuring that individual playback sessions enforce parental controls in real time without requiring channel switching or group disruption. Additionally, playback logs or parental override events may be captured locally or reported to the parent/guardian's account dashboard. Optional settings may include: PIN-protected overrides, Content preview options, or Delayed resume policies that allow context review before resumption.

### Trial Mode Functionality for Device Evaluation and Temporary Access

a. In one embodiment, the system includes a trial mode that allows prospective device owners to evaluate service capabilities before fully committing to ownership or installation. This supports both hardware and software onboarding flexibility while maintaining compliance with geographic access restrictions.
b. Two trial workflows are supported:

### Owner-Supplied Device Trial

A potential subscriber provides their own device for temporary installation within the datacenter, subject to verification and network provisioning.

### Datacenter-Supplied Device Trial

The datacenter sells or leases a compatible device to the prospective owner for use during the trial period.
a. In both cases, trial access is provisioned based on the physical presence of the user, which is temporarily treated as qualifying geographic eligibility. For example, the user's mobile device may be detected within the broadcast DMA (Designated Market Area) using GPS, IP, or proximity scanning. During the trial setup:

A QR code is displayed to the prospective user. Scanning the code initiates download of the companion app. The app is linked to the device using credentials that may be entered manually or scanned. Once linked, the user can test streaming functionality from their assigned device.
a. Because physical presence during trial mode does not guarantee long-term geographic eligibility, the system performs a secondary address verification. This ensures the user resides within the authorized area for permanent device installation. If the address fails verification, continued service may be denied, and the device removed or deactivated.
b. This staged approach enables compliant service sampling while preserving legal safeguards around geographic broadcast rights.
c. Absolutely—the concept of temporary ownership or access during trial mode is legally significant, especially for avoiding classification as retransmission or infringing use under copyright law. Here's an enhanced Detailed Description section with explicit coverage of temporary ownership to reinforce that the system remains compliant during trial use:
d. Enhanced Trial Mode with Temporary Ownership and Legal Safeguards
e. In one embodiment, the system supports a trial mode that allows a prospective subscriber to evaluate the streaming service and hardware capabilities before full activation. To ensure continued compliance with copyright and retransmission regulations, the system incorporates a temporary ownership or control structure during the trial period.
f. Two trial modes are supported:
   Trial with Owner-Supplied Device

The prospective subscriber provides their own device, which is temporarily installed in the datacenter and linked exclusively to the trial user's account. During the trial, the device is under the exclusive control of the trial user, who has individualized access to it through a secure app and credentialed login.

Trial with Datacenter-Supplied Device

The datacenter may temporarily assign a device to the user, configured so that only the trial user has access to it during the evaluation period. While legal ownership may remain with the datacenter, the device is logically and exclusively controlled by the individual trial user, and no shared access is permitted. This approach maintains compliance by ensuring that each user's content access occurs only through a device under their temporary exclusive use, consistent with private-use exemptions.
a. To initiate the trial: The user's physical presence is verified within the DMA region (e.g., via GPS, IP address, or proximity scanning). A QR code is displayed and scanned to download the user app. Credentials are entered or scanned to bind the app to the user's temporary trial device. Streaming begins once the app is linked to the user-specific device.
b. Because temporary physical presence does not equate to long-term geographic eligibility, the system performs a subsequent address verification. Only upon successful verification that the user resides within the appropriate DMA will permanent device activation be permitted. Otherwise, access is suspended and the device is removed or reassigned.
c. This framework of individualized control with time-limited device assignment ensures that trial use does not constitute retransmission or public performance, preserving the legal model of individualized reception aligned with ABC v. Aereo principles.
d. In trial mode, the prospective user is granted exclusive control of a dedicated reception device hosted in the datacenter. To maintain legal compliance under copyright law, the trial user's rights during this period are structured as temporary ownership or a time-limited license of the physical hardware. This means the trial user is considered the effective owner of the device during the evaluation period, even if the hardware is later revoked or reassigned. This ownership structure is reflected in app registration, device provisioning, and network assignment, ensuring that the content accessed by the user is received through a legally distinct, user-specific unit.
e. Ad Signaling and Insertion System

In one embodiment, the system supports advanced advertising workflows using in-band and out-of-band ad signaling. Ad insertion points within a television or video stream may be identified using any industry-standard or proprietary signaling methods, including: SCTE-35, Dual Tone Multi-Frequency (DTMF), File-based signaling, IP-based or metadata triggers. Other emerging advertising standards
a. These markers indicate the start and stop boundaries of ad inventory and are processed by a Local Ad Splicer (LAS 430). LAS 430 may be hardware-or software-based and performs the following operations: Signal Reception:

LAS 430 receives the main program signal—containing both primary content and ad markers-via broadcast (ATSC) or IP-based transport streams (e.g., UDP, RTP, SRT, HLS, MPEG-DASH). Marker Processing and Ad Replacement:

The system parses ad markers (e.g., SCTE-35) and replaces national, affiliate, or previously inserted ads with web-based advertising content. This may be dynamically selected from real-time bidding systems or ad servers from platforms such as: Google Ads/YouTube, Facebook/Instagram, Broadcaster-owned platforms, OpenX, Media.net, AdThrive, Ezoic, PubMatic, AppNexus, etc.
b. Signal Transmission:

The modified signal—including substituted local or targeted ads—is transmitted to the viewer using: Traditional RF/ATSC transmission, IP-based transport protocols such as UDP, RTP, RTMP, SRT, HLS, or MPEG-DASH
c. Encoder Integration:

An optional Encoder 420 prepares the video stream for transmission and may integrate ad marker insertion or frame-accurate encoding aligned to SCTE-35 markers or frame tags.
d. This ad splicing and delivery system enables highly flexible, standards-compliant monetization workflows within both ATSC broadcast environments and IP-based streaming systems.
e. AD location markers and all ad signaling and data can utilize any form of in-band or out-of-band signaling, such as SCTE-35, Dual Tone Multi-Frequency (DTMF), file data, or other ad signaling methods or advertising standards. Encoder 420 is an optional encoding processing unit often used in TV distribution. Local Ad Splicer 430 is a device used in television broadcasting to insert local advertisements into a broadcast stream typically using SCTE-35 or similar data to identify ad data in video streams. Local Ad Splicer 430 includes Signal Reception: The splicer receives the broadcast signal, which includes both the main content (like a TV show or sports event) and markers indicating where ads can be inserted. Ad Markers often defined by standards like SCTE-35, signal the start and end points for ad insertion. Processing (hardware or software) performs video ad insertion using the data provided in ad markers (SCTE-35 or other) replacing the national or affiliate or local ads with web-based ads from any web-based ad provider such as Google, Youtube, Facebook, Instagam, broadcaster or affiliate ad sales web-based ad management and delivery, OpenX,Media.net, AdThrive, Ezoic, Propeller Ads, PubMatic, AppNexus and others. Signal transmission is also performed by LAS 430 sending the modified signal, now containing the local ads to viewers over the air using an ATSC broadcast or over the Internet or a private network. In FIG. 4 Transmitter 440 is any form of RF transmitter and can be replaced by IP network transmission using UDP, HLS, MPEG DASH, RTP, RTMP, SRT or similar network protocol.
f. In some embodiments, the datacenter maintains an inventory of ATSC-compatible set-top boxes (STBs) or reception devices available for sale, lease, or assignment to new users. Upon receiving a valid application, the datacenter may provision a device from inventory and transfer temporary or permanent ownership to the user, such as through a trial period or immediate sale. The device is then installed in the datacenter under the user's account and physically isolated for exclusive access. This model allows the datacenter to act as a compliant hardware provisioning agent without assuming control of content or user access rights, and supports seamless onboarding for users who do not already own compatible devices.

Existing parental control systems often rely on coarse or generalized content ratings that may not align with individual user preferences or household standards. To address this, the system introduces an enhanced content filtering mechanism that allows device owners to create or apply custom blocking rules beyond standard TV ratings. This includes program-specific and channel-level blocking options configurable per user account. Additionally, curated blocklists can be provided by trusted individuals or organizations—such as community groups, schools, or religious institutions—allowing users to apply pre-vetted content filters aligned with their values. These blocklists may be shared, updated remotely, and enforced through the datacenter's app interface or the user's device.

The enhanced parental control and content filtering system may also include optional age-based filtering that maps individual programs to one or more user-defined age categories. Owners can configure viewing profiles based on household member age ranges (e.g., toddler, pre-teen, teen, adult), and the system will dynamically block or allow content accordingly. These settings are enforced both at the device level and within the app interface. Furthermore, the system may incorporate machine learning algorithms that analyze past viewing behavior, reported user preferences, and content metadata to suggest programs that should be blocked or flagged for review. The AI engine can be trained on both local data and anonymized usage patterns across similar devices or households to improve accuracy over time. Suggested changes to parental controls can be presented to the owner for approval or auto-applied based on user-defined thresholds.

The enhanced parental control and content filtering system may also include optional age-based filtering that maps individual programs to one or more user-defined age categories. Owners can configure viewing profiles based on household member age ranges (e.g., toddler, pre-teen, teen, adult), and the system will dynamically block or allow content accordingly. These settings are enforced both at the device level and within the app interface. Furthermore, the system may incorporate machine learning algorithms that analyze past viewing behavior, reported user preferences, and content metadata to suggest programs that should be blocked or flagged for review. The AI engine can be trained on both local data and anonymized usage patterns across similar devices or households to improve accuracy over time. Suggested changes to parental controls can be presented to the owner for approval or auto-applied based on user-defined thresholds. 21. Existing parental control systems often rely on coarse or generalized content ratings that may not align with individual user preferences or household standards. To address this, the system introduces an enhanced content filtering mechanism that allows device owners to create or apply custom blocking rules beyond standard TV ratings. The system further supports age-based content filtering, where users can set age thresholds to automatically block programs not suitable for specified age groups, using industry ratings and metadata. Machine learning models may also be applied to analyze program transcripts, descriptions, or historical viewing patterns to recommend or automatically apply content restrictions aligned with user-defined sensitivities. This includes program-specific and channel-level blocking options configurable per user account. Additionally, curated blocklists can be provided by trusted individuals or organizations—such as community groups, schools, or religious institutions—allowing users to apply pre-vetted content filters aligned with their values. These blocklists may be shared, updated remotely, and enforced through the datacenter's app interface or the user's device. 18. In the group addressing configuration, the encryption and decryption of video streams are managed through a group key mechanism.

Business Method and Compliance Description: This invention includes a business method for operating a compliant ATSC television reception service using distributed user-owned devices hosted in a managed datacenter. The business method comprises steps for verifying user eligibility based on geographic location, assigning or installing a user-owned device in a facility, and providing secure access to the reception output of that specific device. Each user is contractually granted control over a device colocated in the datacenter, and the datacenter operator functions solely as a space and network service provider without offering content access or retransmission. Trial access is treated as a temporary assignment of ownership for compliance purposes. Revenue may be generated through datacenter hosting fees, equipment sales, ad insertion revenue, or subscription services layered on top of the user's legal access rights. This model avoids the centralized retransmission issues found noncompliant in ABC v. Aereo by strictly preserving device-to-user ownership links and eliminating shared delivery paths for decoded content.

Ad Manager and Ad Scheduling System with Broadcaster and Local Ad Replacement

Ad Manager (AM) 450 performs novel functions to manage advertisement replacement across user-owned devices and applications. Upon receiving ad markers—either in-band (e.g., SCTE-35) or out-of-band (e.g., external metadata or schedule files)—AM 450 evaluates current ad scheduling logic and determines replacement content. It communicates with Set-Top Boxes (STBs) or client applications owned by datacenter members through an STB interface 455 and network connection 457. The ad replacement data may also be transmitted directly to video playback applications operated by verified device owners without using an STB.

Ad replacement may be performed locally on the user's STB, within the playback application, or through remote sources such as: A cloud-based ad insertion system, Processing at the broadcaster or affiliate level, Software operating inside the owner's device or player application.

Ad Scheduler 451 is an enhanced version of a standard ad scheduling system. It is designed to support the fulfillment and substitution of local and broadcaster advertising avails. An “ad avail” refers to a time slot within the content schedule that is available for advertisements. These slots may be filled dynamically with new ads, including web-based advertisements, based on monetization goals, targeting parameters, or yield optimization.

Throughout this application, the terms “marker,” “ad marker,” “marker data,” or “ad slot indicator” refer to the data used to identify the boundaries or timestamps of an ad opportunity. Ad marker data may be embedded in the video stream, such as through SCTE-35 standards, or may be provided out-of-band via metadata files, scheduling feeds, or external control systems.

While Ad Splicer 453 is illustrated as an interface to Local Ad Splicer 430, which replaces or inserts local advertisements, AM 450 may also be used to identify and replace broadcaster-inserted ads. These are ads inserted by national broadcasters such as Fox or NBC. In traditional broadcast workflows, SCTE-35 markers used to identify broadcaster ad avails may be stripped out after insertion, leaving only local ad markers in the stream. However, in the present invention, encrypted ad marker data may be inserted into the stream—either by the broadcaster, affiliate, or content distributor—allowing AM 450 to detect and process these slots for replacement.

An inventive step includes enabling AM 450 to: Decrypt encrypted ad marker data within the video stream; Receive broadcaster or affiliate ad scheduling metadata indicating the location of ad avails; Replace broadcaster-inserted ads with new video ads selected from programmatic or managed sources; Improve monetization by increasing advertising yield per avail through targeted or dynamically inserted ads.

Synchronization between the ad slot and replacement content may be accomplished through timecodes, frame-accurate SCTE-35 markers, encrypted timestamps, or other video alignment techniques embedded by the content source.

Ad Manager (AM) 450 performs inventive steps to receive ad markers, check ad scheduling, send STB related ad splicing data to device owners STB or device owner applications with data used to replace linear broadcast ATSC TV ads in owner devices (not shown) or owner applications connected to the Ad Manager 450 via the STB (owners' STB) interface 455 and network connection 457, or a direct connection from owner player device (not the owner STB) to a web-based ad provider. Other sources and processing for obtaining and replacing broadcaster or affiliate ads is envisioned including cloud processing, processing at the broadcaster, processing at the affiliate, processing in the owners STB or processing in the owners application used to play the video.

Ad Scheduler 451 is a standard ad scheduler enhanced to include replacing or fulfilling local ad avails with replacement ads managed by enhanced software in Ad Scheduler 451. An “ad avail” (short for “advertising availability”) refers to a specific time slot within a broadcast or streaming schedule that is available for advertisements. These slots are pre-determined and can be sold to advertisers who want to promote their products or services during that time. Ad avails are crucial for broadcasters and streaming services as they generate revenue through the sale of these advertising slots. In this patent application the use of the term marker, marker data or ad marker or similar will be used to identify the ad slot location in a video stream. Ad marker data can be in the stream such as specified by SCTE-35 standard, or out of band meaning data separated from the video stream that identifies the ad slot. Out of band ad marker is stored in a file or other data storage technique.

While the Ad Splicer 453 is shown as an interface to the Local Ad Splicer 430 for local ad management and ad replacement and ad targeting, AM 450 can also replace broadcaster ads in addition to local ads. Broadcaster ads are the ads put into the video stream by the broadcaster such as Fox Broadcasting Company (FOX) or the National Broadcasting Company (NBC). Local or affiliate ads are ads that a local affiliate of a broadcaster has been provided for by the broadcaster. For example, FOX San Diego channel 5 and FOX New York are affiliates of the Fox Broadcasting Company.

Broadcaster ads typically have SCTE-35 markers for the broadcaster ads removed after broadcaster ad insertion, leaving only the ad marker data for the local ad avails. An inventive step in this patent application is the replacement of broadcaster ads with new ads whereby the new ad increases the advertising rate for the broadcaster. Encrypted ad marker data is added to the broadcasters' video stream allowing Ad Manager 450 to decrypt the marker data. In addition to encrypted marker data in the stream ad splicing data for broadcaster ads can be supplied to Ad Manager 450 with scheduling data from the broadcaster or the local affiliate or both. Broadcaster ad slot (ad avail) data indicates where in the video stream broadcaster ads are located and ad manager 450 replaces broadcaster ad video with new advertising video. Ad manager 450 incorporates any form of ad of synchronizing ad slot with ad insertion including encrypted marker containing ad slot time stamp, or other data indicating ad slot location in the video stream supplied by the content source such as the broadcaster.

There are many ways in which both Broadcaster inserted ads and Affiliate inserted ad replacement can be performed anywhere in the video delivery process including server side processing, affiliate processing, processing in the owners STBs, processing in the owners player app. One example used to illustrate the process is provided in the steps below.

Broadcaster inserts ads during broadcaster video processing including marking affiliate ad slots. Ad marker data such as SCTE-35 or other marker data for affiliate ad slot is added to the video stream.

Optionally, an encrypted ad marker data for broadcaster ad is added by the broadcaster marking location of broadcaster ad that is available to be replaced under certain conditions. Broadcaster encrypted ad marker can be encrypted in the video (in-band) SCTE-35 data or other data marking ad location, or it can be other data in the video stream or delivered external from the video stream often referred to as out-of-band or separate file data identifying broadcaster ad location in the video stream. Encrypted broadcaster ad marker data is private to only the broadcaster and managed by the broadcaster. The broadcaster will use this encrypted ad marker at a later point to replace the ad data in the ad slot with encrypted ad marker data with another ad. This broadcaster added encrypted ad marker is different and unrelated to the SCTE-35 (or similar) ad marker added for the affiliate ads.

Broadcaster streams video stream is transmitted to affiliates over satellite, or fiber or any other transmission technology.

Affiliate receives broadcaster stream with affiliate ad slots with ad slot markers and affiliate inserts a local ad of any kind. Local ad can be a paid ad, a local affiliate promotional ad such as promoting the local affiliates weather team, or any other type of image or video. This is standard local ad processing and ad insertion by the affiliate up to this point.

In addition, affiliate adds an encrypted ad marker marking the affiliate ad slot location for replaceable ads, or affiliate saves data identifying the video location of the affiliate ad slot so that at a later time the affiliate can replace the affiliate ad. Affiliate added ad slot marker data can be encrypted marker data in the video stream or marker data out of the video stream (out-of-band) such as file data.

The local ad inserted at this point with affiliate added affiliate ad (local ad) will be broadcasted out using the ATSC 1.0 or 3.0 RF signal. All viewers receiving the affiliate signal broadcasted at this point will see the same ad inserted by the affiliate. In some systems the affiliate ad slot will not have encrypted ad marker data added to the video stream, rather it will have out-of-band data stored in a file external to the video stream that is used for ad processing. Regardless of in-band encrypted ad marker data or out of band identifying the affiliate ad slot, data is available to identify the affiliate ad slot.

In separate ad processing hardware or in modified ad insertion hardware or software at the affiliate or at broadcaster site or data from any ad processing in the ad distribution chain, an indicator is generated indicating that a local or national ad slot is available for replacement and is referred to as a ‘replaceable ad slot’ or ‘replacement ad slot’. Replacement ad slots are slots where ad processing at any location including server side ad processing, or ad processing in the owners STB, or ad processing in the application being used by an owner to play the video is notified that this is a slot where a different ad can be inserted into this slot, thus replacing the prior video in this ad slot. Replacement ad slot notification can be any form of data in the video stream (in-band) or out of band with data supplied by any hardware component in the system and examples include MPEG time-stamp data, timing offset data from a specific video time reference, time of day reference, or any other form of data that can accurately identify the replaceable ad slot. In one example, the affiliate ad traffic manager/schedule inserts an affiliate promotional ad with additional data indicating this slot is a ‘replaceable ad slot’. In another example, the broadcasters ad insertion hardware adds the ‘replacement ad slot’ identifier. In another example, broadcast ad traffic manager/ad scheduler software creates a timing or similar manifest indicating replaceable ad slots. Other methods of indicating a replaceable ad slot are envisioned. One of the purposes of the replaceable ad slot is to provide ad locations where a different ad can be inserted from other sources or at a later time. Replaceable ad slot data preferably is encrypted and is any form of data that indicates the location of the replaceable ad slot in both Video-On-Demand (VOD) and live TV video. Any or all of the data associated with ad processing can be encrypted even the original ad or replacement ad.

Ad processing at the affiliate, at the broadcaster, in the owners stbs, in the owner's app, or in any combination including in the cloud detects replaceable ad slots. Replaceable ad slot encrypted markers are decrypted and when replacements ads are available from any source, the originally added ad video is replaced with ad video from the replacement ad source. Ad processing upon detecting the replaceable ad slot obtains additional data used to replace the ad with a new ad from any source. Additional ad processing data provided in-band or out-of-band or from file data provides data associated with how the ad replacement should be processed. Any form of data indicating replacement ad sources such as ads received from Google, Youtube, Bing, Facebook, or Instagram, or ad exchanges or ad networks.

Ad sources for replacement ads can use any standard protocol such as VAST, VPAID, VMAP or MRAID for example. Ad tags (code snippets) are integrated from the ad network. Ad tags are used to manage where ads are to appear. A few examples of ad tags are ads when opening the app, ads on channel change, ads pre-roll, post-roll interstitial ads, banner ads, L shaped ads, and many other ad placement locations and ad types. Additional ad replacement data may include targeting data such as geographic targeted locations, device targets, owner viewing habits, time of day/day of week, etc. It is envisioned that multiple ad replacement sources (ad exchanges, ad networks, broadcaster or affiliate ad traffic managers, or other sources) are supported. Original or replacement ad can optionally have video related ad tags for different ad types, such as promoting a banner ad to an “L” shaped video ad, or a static image ad to a video ad. In most ad replacements the original ad time duration in seconds will be matched by the replacement ad. In some cases the replacement ad will be longer than the replacement ad and the ads or video following the original ad will be buffered until the replacement ad of longer duration finishes.

Ad support for web type ads and video type ads are supported. Web type ads are typically image, text, or video in various formats such as banners, pop-up ads, sidebar ads, L-shaped ads and other ad types and formats. Video ads are ads that play before (pre-roll), within (mid-roll), or after (post-roll) for the main TV content such as live TV streams, VOD, or Catchup TV. Pre-roll, mid-roll, and post-roll ads can originate from multiple different ad exchanges or ad networks and work with or without splicing the actual video. Ad processing in data center, or in owners STBs, or at the network edge, or in the device owners player app interfaces to various ad sources of any kind to obtain and insert ads into the replaceable ad slot as well as normal web site based ad processing on app web pages. Ads can be supplied from multiple sources such as ad exchanges, ad networks, broadcaster of affiliate ad systems, third party ad sources, or other ad sources.

Targeting can be incorporated into the ad processing based on user data, user demographics, user location, device owner's physical player device, gender, interests, or other data used within the targeted advertising business. In this patent application the term device owner's player device, or user device, or player app or player application or similar are used to reference the device displaying video and ads to the device owner.

Analytics associated with the original ad or replacement ad or both are processed by any processing in the ad system. Advertisers typically require a range of VAST (Video Ad Serving Template) ad analytics to measure the effectiveness and performance of their video ads. Replacement ad processing optionally reports on any one or more of the ad analytics including but not limited to:

Impressions: The number of times an ad is displayed to viewers.

Viewability: Measures whether an ad was actually viewable by the audience, often defined by a certain percentage of the ad being visible for a minimum duration.

Completion Rates: Tracks how many viewers watched the ad to completion, often broken down by quartiles (25%, 50%, 75%, 100%). Click-Through Rates (CTR): The percentage of viewers who clicked on the ad.

Engagement Metrics: Includes interactions such as clicks, hovers, and other user actions taken during the ad.

Error Rates: Tracks any issues or errors that occurred during ad playback.

Ad Skips: Measures how often viewers skip the ad, if skippable.

Ad Start and End Times: Records the exact times when the ad started and ended.

Ad Duration: The total length of time the ad was played.

Ad Break Performance: Analytics related to ads shown during breaks in content, including mid-roll and post-roll ads.

rewrite 1. Broadcaster inserts ads during broadcaster video processing including marking affiliate ad slots. Ad marker data such as SCTE-35 or other marker data for affiliate ad slot is added to the video stream.

2. Optionally, an encrypted ad marker data for broadcaster ad is added by the broadcaster marking location of broadcaster ad that is available to be replaced under certain conditions. Broadcaster encrypted ad marker can be encrypted in the video (in-band) SCTE-35 data or other data marking ad location, or it can be other data in the video stream or delivered external from the video stream often referred to as out-of-band or separate file data identifying broadcaster ad location in the video stream. Encrypted broadcaster ad marker data is private to only the broadcaster and managed by the broadcaster. The broadcaster will use this encrypted ad marker at a later point to replace the ad data in the ad slot with encrypted ad marker data with another ad. This broadcaster added encrypted ad marker is different and unrelated to the SCTE-35 (or similar) ad marker added for the affiliate ads. 3. Broadcaster streams video stream is transmitted to affiliates over satellite, or fiber or any other transmission technology.

4. Affiliate receives broadcaster stream with affiliate ad slots with ad slot markers and affiliate inserts a local ad of any kind. Local ad can be a paid ad, a local affiliate promotional ad such as promoting the local affiliates weather team, or any other type of image or video. This is standard local ad processing and ad insertion by the affiliate up to this point.

In addition, affiliate adds an encrypted ad marker marking the affiliate ad slot location for

replaceable ads, or affiliate saves data identifying the video location of the affiliate ad slot so that at a later time the affiliate can replace the affiliate ad. Affiliate added ad slot marker data can be encrypted marker data in the video stream or marker data out of the video stream (out-of-band) such as file data. 6. The local ad inserted at this point with affiliate added affiliate ad (local ad) will be broadcasted out using the ATSC 1.0 or 3.0 RF signal. All viewers receiving the affiliate signal broadcasted at this point will see the same ad inserted by the affiliate. In some systems the affiliate ad slot will not have encrypted ad marker data added to the video stream, rather it will have out-of-band data stored in a file external to the video stream that is used for ad processing. Regardless of in-band encrypted ad marker data or out of band identifying the affiliate ad slot, data is available to identify the affiliate ad slot. 7. In separate ad processing hardware or in modified ad insertion hardware or software at the affiliate or at broadcaster site or data from any ad processing in the ad distribution chain, an indicator is generated indicating that a local or national ad slot is available for replacement and is referred to as a ‘replaceable ad slot’ or ‘replacement ad slot’. Replacement ad slots are slots where ad processing at any location including server side ad processing, or ad processing in the owners STB, or ad processing in the application being used by an owner to play the video is notified that this is a slot where a different ad can be inserted into this slot, thus replacing the prior video in this ad slot. Replacement ad slot notification can be any form of data in the video stream (in-band) or out of band with data supplied by any hardware component in the system and examples include MPEG time-stamp data, timing offset data from a specific video time reference, time of day reference, or any other form of data that can accurately identify the replaceable ad slot. In one example, the affiliate ad traffic manager/schedule inserts an affiliate promotional ad with additional data indicating this slot is a ‘replaceable ad slot’. In another example, the broadcasters ad insertion hardware adds the ‘replacement ad slot’ identifier. In another example, broadcast ad traffic manager/ad scheduler software creates a timing or similar manifest indicating replaceable ad slots.

Other methods of indicating a replaceable ad slot are envisioned. One of the purposes of the replaceable ad slot is to provide ad locations where a different ad can be inserted from other sources or at a later time. Replaceable ad slot data preferably is encrypted and is any form of data that indicates the location of the replaceable ad slot in both Video-On-Demand (VOD) and live TV video. Any or all of the data associated with ad processing can be encrypted even the original ad or replacement ad. 8. Ad processing at the affiliate, at the broadcaster, in the owners stbs, in the owner's app, or in any combination including in the cloud detects replaceable ad slots. Replaceable ad slot encrypted markers are decrypted and when replacements ads are available from any source, the originally added ad video is replaced with ad video from the replacement ad source. Ad processing upon detecting the replaceable ad slot obtains additional data used to replace the ad with a new ad from any source. Additional ad processing data provided in-band or out-of-band or from file data provides data associated with how the ad replacement should be processed. Any form of data indicating replacement ad sources such as ads received from Google, Youtube, Bing, Facebook, or Instagram, or ad exchanges or ad networks. 9. Ad sources for replacement ads can use any standard protocol such as VAST, VPAID, VMAP or MRAID for example. Ad tags (code snippets) are integrated from the ad network. Ad tags are used to manage where ads are to appear. A few examples of ad tags are ads when opening the app, ads on channel change, ads pre-roll, post-roll interstitial ads, banner ads, L shaped ads, and many other ad placement locations and ad types. Additional ad replacement data may include targeting data such as geographic targeted locations, device targets, owner viewing habits, time of day/day of week, etc. It is envisioned that multiple ad replacement sources (ad exchanges, ad networks, broadcaster or affiliate ad traffic managers, or other sources) are supported. Original or replacement ad can optionally have video related ad tags for different ad types, such as promoting a banner ad to an “L” shaped video ad, or a static image ad to a video ad. In most ad replacements the original ad time duration in seconds will be matched by the replacement ad. In some cases the replacement ad will be longer than the replacement ad and the ads or video following the original ad will be buffered until the replacement ad of longer duration finishes. 10. Ad support for web type ads and video type ads are supported. Web type ads are typically image, text, or video in various formats such as banners, pop-up ads, sidebar ads, L-shaped ads and other ad types and formats.

Video ads are ads that play before (pre-roll), within (mid-roll), or after (post-roll) for the main TV content such as live TV streams, VOD, or Catchup TV. Pre-roll, mid-roll, and post-roll ads can originate from multiple different ad exchanges or ad networks and work with or without splicing the actual video. Ad processing in data center, or in owners STBs, or at the network edge, or in the device owners player app interfaces to various ad sources of any kind to obtain and insert ads into the replaceable ad slot as well as normal web site based ad processing on app web pages. Ads can be supplied from multiple sources such as ad exchanges, ad networks, broadcaster of affiliate ad systems, third party ad sources, or other ad sources. 11. Targeting can be incorporated into the ad processing based on user data, user demographics, user location, device owner's physical player device, gender, interests, or other data used within the targeted advertising business. In this patent application the term device owner's player device, or user device, or player app or player application or similar are used to reference the device displaying video and ads to the device owner. 12. Analytics associated with the original ad or replacement ad or both are processed by any processing in the ad system. Advertisers typically require a range of VAST (Video Ad Serving Template) ad analytics to measure the effectiveness and performance of their video ads. Replacement ad processing optionally reports on any one or more of the ad analytics including but not limited to: a. Impressions: The number of times an ad is displayed to viewers. b. Viewability: Measures whether an ad was actually viewable by the audience, often defined by a certain percentage of the ad being visible for a minimum duration. c. Completion Rates: Tracks how many viewers watched the ad to completion, often broken down by quartiles (25%, 50%, 75%, 100%). d. Click-Through Rates (CTR): The percentage of viewers who clicked on the ad. e. Engagement Metrics: Includes interactions such as clicks, hovers, and other user actions taken during the ad. f. Error Rates: Tracks any issues or errors that occurred during ad playback. g. Ad Skips: Measures how often viewers skip the ad, if skippable. h. Ad Start and End Times: Records the exact times when the ad started and ended. i. Ad Duration: The total length of time the ad was played. j. Ad Break Performance: Analytics related to ads shown during breaks in content, including mid-roll and post-roll ads.
a. Any or all of the above ad processing described herein including analytics are processed by any processing in the ad replacement processing described herein can be performed at any location including server-side ad insertion, demand side ad insertion.
b. Any or all of the ad processing described herein, including analytics, can be performed at any location. This includes server-side ad insertion, demand-side ad insertion, owner STB ad insertion, owner player app insertion or a combination of any processing locations such as server-side processing combined with owner player ad processing in a Smart LG or Samsung TV for example.
c. A trial mode is supported where potential device owners can test the device before buying a device. In one trial mode an owner device is supplied to the data center. In a second trial mode the data center sells a device for use by the owner. Trial mode is supported where the device owner's physical address is used to temporarily establish physical presence and the right to receive copyrighted material broadcasted in the area where the device owner is currently located. A QR code is displayed that the device owner scans to download their app. App credentials are entered or scanned and the app is linked to the owner's device. At this point the owner can use the device and evaluate the streaming capabilities of their device. Because a device owner's physical presence is used as a temporary indication that they are entitled to receive copyrighted materials, this may not in fact be their physical address and they may not live in an area where they are entitled to have their device installed in the area data center. As such, a subsequent address verification is performed verifying they live in an appropriate location for installing their device in the data center.

What is claimed:

1. A method of managing user-owned ATSC television reception devices in a datacenter, the method comprising: verifying a physical address associated with a user requesting installation of a device: installing the device in a datacenter upon successful verification of the user's address: providing network connectivity to the installed device: and supplying electrical power to the installed device.

2. The method of claim 1, further comprising providing an ATSC antenna signal to a plurality of applicant devices via one or more antennas installed at the datacenter.

3. The method of claim 1, wherein the business method further comprises: performing periodic verification of the physical address associated with the installed applicant device: determining, based on the verification, whether the applicant remains entitled to access geographically restricted ATSC television signals: and disabling the applicant device upon determining that the verified address no longer qualifies under the geographic restriction.

4. The method of claim 1, wherein the verification of the physical address for a datacenter applicant comprises: transmitting a printed letter containing a unique registration code to the applicant's physical address via the United States Postal Service or another delivery service: requiring the applicant to enter the unique registration code to confirm the address: and disabling or limiting operation or disconnecting the network connection to the applicant's device if the registration code is not entered within a specified time period.

5. The method of claim 1, wherein the address verification may occur over a predetermined time period, during which network and power connections are provided to the applicant device, and wherein such connections are limited or terminated if address verification is not successfully completed within the predetermined time period, wherein said limitation or termination is enforced through firmware within the applicant device or hardware that is under the control of the datacenter operator.

6. A datacenter system for managing devices that access geographically restricted television signals, the system comprising: an intake interface configured to either receive a user-owned device from a user located within a predetermined geographic region or provide a device from datacenter inventory for use by the user: a verification module configured to validate that the user's physical address satisfies predefined geographic eligibility criteria: a power supply configured to provide electrical power to the device: and a network interface configured to enable remote access to the device.

7. The system of claim 6, further comprising an antenna interface configured to connect the device to an antenna feed located at the datacenter, the antenna feed being configured to receive over-the-air television signals corresponding to the geographic region associated with the user's verified address.

8. The system of claim 6, wherein the device comprises two geographically separated ATSC television signal processing circuit elements, wherein a first processing circuit element is housed within the datacenter and configured to perform a portion of the ATSC signal processing, and wherein a second processing circuit element is located external to the datacenter and is configured to complete the remaining ATSC signal processing required to display the television signal on a display device or within a software application configured to render ATSC audio and video content.

9. The system of claim 6, wherein the device includes a user interface located external to the datacenter, the user interface being configured to remotely control one or more operational settings of the device via the network connection.

10. The system of claim 6, wherein the datacenter is configured to receive a channel feed from a first user-owned device associated with a particular television channel, and to connect multiple other datacenter users requesting the same channel to that first device, wherein the datacenter manages the network connections between the users and the first user-owned device, such that the output of the first device is shared with the other users.

11. The system of claim 10, wherein the channel feed from the first user-owned device is encrypted, and wherein an associated decryption key is provided only to device owners who are registered with the datacenter and whose physical addresses have been validated as eligible under the geographic restrictions.

12. The system of claim 11, wherein, upon a request by a device owner to change channels while their device is serving as a shared feed source for other users, the datacenter is configured to maintain the owner's device on the original channel being viewed by the group, and to redirect the device owner's session to a second device already tuned to the requested channel, wherein the owner's device remains assigned to the original channel until no other users remain connected to that channel feed, or for an extended period as determined by the datacenter operator.

13. The system of claim 11, wherein, upon a request by a device owner to change channels while their device is serving as a shared feed source for other users, a group address channel manager module is configured to maintain the owner's device on the original channel being viewed by the group, and to redirect the owner's session to a second device already tuned to the requested channel, wherein the owner's device remains assigned to the original channel until no other users remain connected to that channel feed, or for an extended period determined by the group address channel manager module.

14. The system of claim 6, further comprising a video storage manager configured to link a user-owned device that provides video storage and playback functionality to other verified members of the datacenter, thereby enabling shared access to stored television content among members operating as a group-based digital video recorder (DVR).

15. The system of claim 6, further comprising a software application configured to operate on a mobile device, smart television, or computing platform, wherein the application enables a verified subscriber to remotely access their user-owned device hosted in the datacenter, initiate playback of ATSC broadcast content, and decrypt content received via group addressing using a conditional access system that authorizes playback based on the subscriber's verified geographic eligibility.

16. The system of claim 6, further comprising a secure access system configured to authenticate a client application with both the datacenter network and a user-owned device,
wherein the datacenter is further configured to route authenticated session requests to the user-owned device using one of: (a) direct IP addressing: (b) a proxy routing mechanism that maps session requests to the device: or (c) a transparent access bridge that dynamically enables or disables network passthrough based on the account status of the requesting user, wherein the secure access system further supports shared access to a channel feed from the user-owned device by a plurality of verified users, thereby enabling scalable and secure individual and group access to devices hosted within the datacenter.

17. The system of claim 6, further comprising an ad manager system configured to receive advertisement marker data from a video stream or from out-of-band metadata, and to transmit replacement advertisement insertion data to a user-owned set-top box or playback application.
wherein the replacement advertisements are inserted into the video content locally on the user device during playback.

18. The system of claim 6, wherein the ad marker data identifies both local ad avails and broadcaster-inserted advertisement segments, and wherein the ad manager system is configured to replace broadcaster-inserted advertisements with dynamically selected video advertisements based on ad scheduling logic or revenue optimization criteria.

19. Claim 6 wherein the ad marker data identifies both local and broadcaster ad avails, and wherein the ad manager system is configured to replace broadcaster-inserted advertisements with dynamically selected video ads, based on ad scheduling logic or revenue optimization criteria.

20. The system of claim 6, further comprising a trial mode, wherein a prospective user is granted temporary access to a device hosted in the datacenter, and wherein the device is under the exclusive control of the user during the trial, either through temporary ownership, conditional sale, or individualized assignment that prohibits concurrent access by other users, and wherein initial qualification is based on the user's geographic presence, followed by secondary verification of the user's residential address to determine long-term eligibility for continued use.
